(19) United States
(12) Patent Application Publication
(10) Pub. No.: US 2025/0154399 A1
(43) Pub. Date: May 15, 2025

(54) HYBRID SALOGEL, METHODS OF MAKING HYBRID SALOGELS, AND SYSTEMS USING HYBRID SALOGELS

(71) Applicant: The Texas A&M University System, College Station, TX (US)

(72) Inventors: Svetlana Sukhishvili, College Station, TX (US); Kartik Kumar Rajagopalan, College Station, TX (US); Patrick J. Shamberger, College Station, TX (US)

(21) Appl. No.: 18/941,663

(22) Filed: Nov. 8, 2024

Related U.S. Application Data
(60) Provisional application No. 63/597,384, filed on Nov. 9, 2023.

(51) Int. Cl. C09K 5/06; C08J 3/02; C08J 3/20; C08J 3/24; C08K 3/16; C08K 3/28; C08K 3/38

(52) U.S. Cl. CPC C09K 5/063; C08J 3/02; C08J 3/203; C08J 3/24; C08K 3/16; C08K 3/28; C08K 3/38; C08J 2329/04; C08J 2333/26; C08K 2003/162; C08K 2003/287; C08K 2003/387; C08K 2201/014

(57) ABSTRACT

The present disclosure provides for a hybrid salogel, methods of making hybrid salogels, and systems using hybrid salogels.

### CROSS-REFERENCE TO RELATED APPLICATION

This application claims priority to U.S. provisional application entitled “HYBRID SALOGEL, METHODS OF MAKING HYBRID SALOGELS, AND SYSTEMS USING HYBRID SALOGELS” and having Ser. No. 63/597,384, filed Nov. 9, 2023, which is herein incorporated by reference in its entirety.

### FEDERAL SPONSORSHIP

This invention was made with government support under Cooperative Agreement No. DE-EE0009155 awarded by the U.S. Department of Energy (DOE). The government has certain rights in the invention.

### BACKGROUND

Inorganic salt hydrates are of interest as phase change materials (PCMs) because of their high volumetric energy storage density, enhanced thermal conductivity, and non-flammability compared to their organic counterparts. However, their low viscosity and flowability above their melting point leads to leakage in thermal management applications, requiring shape stabilization of these materials in the liquid phase.

### SUMMARY

The present disclosure provides for a hybrid salogel, methods of making hybrid salogels, and systems using hybrid salogels.

The present disclosure provides for a hybrid salogel comprising: a phase change material (PCM), wherein the hybrid salogel includes about 94 to 99 weight percent of the PCM; a polymer mixture comprising a first polymer and a second polymer, wherein the first polymer is selected from the group consisting of: a polyvinyl alcohol (PVA), a copolymer of PVA, and a homopolymer containing a plurality of hydroxyl groups, wherein the second polymer is polyacrylamide (PAAm) or a copolymer of PAAm, wherein the hybrid salogel includes about 0.2 to about 5 weight percent of the polymer mixture; and a crosslinker, wherein the hybrid salogel includes about 0.1 to 0.5 weight percent of the crosslinker.

The present disclosure provides for a method for preparing a hybrid salogel, the method comprising: adding a polymer powder into a liquid phase change material (PCM) to form a mixture, wherein the polymer powder comprises polyvinyl alcohol (PVA) and polyacrylamide (PAAm); dissolving the powder in the liquid PCM and forming a homogeneous solution; gelling the homogeneous solution; and dissolving the polymer powder into water followed by dissolving a desired quantity of anhydrous salt into a liquid, forming a homogenous solution.

The present disclosure provides for a structure, comprising: a hybrid salogel as described above and herein. In an aspect, the structure can be a storage slab, a storage sheet, a storage pouch, a plate-fin heat exchanger, a shell and tube heat exchanger, a finned tube heat exchanger, a spiral tube heat exchanger, cement, concrete, brick, cinder block, drywall, ceiling tiles, flooring, a textile, and a fabric.

The present disclosure provides for a PCM storage structure, comprising: at least one encapsulated thin storage slab in a storage tank, wherein the at least one encapsulated storage slab could include an inert rigid support structure for further mechanical rigidity and a hybrid salogel as described above and herein.

### BRIEF DESCRIPTION OF DRAWINGS

Further aspects of the present disclosure will be more readily appreciated upon review of the detailed description of its various embodiments, described below, when taken in conjunction with the accompanying drawings.

FIGS. 1A-B are results from temperature sweep rheology experiments, showing a comparison of T_{gel} obtained from temperature sweep rheology experiments for PVA/borax salogels in CNH and CCH (FIG. 1A) and temperature sweep rheology experiments comparing G′ (closed symbols), G″ (open symbols) as a function of temperature for PVA and PVA/borax salogels in CCH and CNH (FIG. 1B). Polymer concentration was 3 wt %.

FIGS. 2A-D are schematics showing (FIG. 2A) DLS experiments comparing hydrodynamic diameter of PVA chains in CNH and CCH at 23° C. for PVA concentration of 0.5 mg/mL. FIG. 2B shows peak wavenumber of PVA hydroxyl group as a function of water concentration (n) in deuterated calcium nitrate (CNnD) and calcium chloride (CCnD) obtained from ATR-FTIR. Dotted line shows the peak wavenumber in bulk water (D₂O). The actual salt hydrate PCMs (CN4D and CC6D) are indicated by arrows. Inset shows the spectra in CND (top) and CCD (bottom). FIG. 2C is schematics showing the gelation mechanism of PVA in CNH and CCH. FIG. 2D is a table indicating at which water concentrations gelation occurs in CNH and CCH at room temperature. PVA concentration was 5 wt % for FTIR and gelation experiments.

FIG. 3 shows temperature sweep rheology experiments comparing ultra-high molecular weight PAAm (6000 kDa) and PAAm (150 kDa) in CCH. Insets show vial inversion experiments showing shape stable gelation with PAAm 6000 kDa (pictures at the top with grey dashed outline) at all temperatures and lack of gelation with PAAm 150 kDa (picture at the bottom with maroon dashed outline). PAAm concentration was 3 wt % for both molecular weights. Temperature sweep was performed at a frequency of 10 rad/s and 1% strain in the viscoelastic regime. Schematics on the right show gelation mechanism for PAAm 6000 kDa.

FIGS. 4A-C show 3D bar plots comparing (FIG. 4A) T_{gel} obtained from temperature sweep rheology experiments for salogels containing PVA/borax/PAAm in different ratios and (FIG. 4B) G′ at 40° C. All the gels contain 4 wt % total polymer. Note that T_{gel} of 100% PAAm salogels in FIG. 4A were greater than 90° C. and could not be measured in the rheological experiments. FIG. 4C is a schematic showing the various interactions involved in the hybrid PVA/borax/PAAm salogels. The gray box in FIG. 4A highlights the relevant T_{gel} range for processibility of salogels.

FIGS. 5A-B show DSC curves for CCH and hybrid (2% PAAm/2% PVA/borax 10 mol %) salogel. FIG. 5B shows the heat of fusion and melting temperature in pristine CCH and hybrid salogels in CCH.

FIGS. 6A-B show the heat of fusion and melting temperature for hybrid (2% PAAm/2% PVA/borax 10 mol %) salogel in FIG. 6A and temperature sweep rheology experiments comparing G′, G″ and T_{gel} of hybrid salogel before and after thermal cycling in FIG. 6B. Temperature sweep rheology experiments performed at a frequency of 10 rad/s and 1% strain.

FIGS. 7A-D show hybrid salogels (2% PAAm/2% PVA/borax 10 mol %) in “T”, “A”, “M”, and “U” shapes with CCH. FIGS. 7A and 7C show a crystallized state at 25° C. FIGS. 7B and 7D show a molten state at 50° C.

FIG. 8 shows a comparison of properties of thickeners, covalent networks, and salogels from literature.

FIGS. 9A-B show ATR-FTIR spectra showing the shift of —OH peak of water in CCH and CNH after deuteration to CCD and CND.

FIG. 10 shows oscillatory rheology temperature sweep experiments performed at a frequency of 10 rad/s and 1% strain comparing G′ (closed symbols), G″ (open symbols) as a function of temperature for PVA/borax salogels in CNH and CCH. PVA concentration was 3 wt %.

FIG. 11 shows vial inversion experiments performed at 25° C. showing the effect of water content on gelation behavior of PVA in CNnH and CCnH. PVA concentration was 5 wt %.

FIGS. 12A-C show leakage of CCH and loss of salogel shape during melting in 3% PVA/5 mol % borax salogels. FIG. 12A shows salogel with CCH in crystallized state. FIG. 12B shows leakage of CCH during melting at 40° C. FIG. 12C shows leakage of CCH and loss of salogel shape upon complete melting of CCH at 40° C. Complete melting took about 20 minutes.

FIG. 13 shows a lack of gelation of PAAm 6000 kDa in water from vial inversion and a schematic showing hydration of amide groups on PAAm backbone.

FIGS. 14A-B show ATR-FTIR spectra showing changes in the (FIG. 14A) amide I peak and (FIG. 14B) —NH stretching peaks in CCD and D₂O. Polymer concentration was 10 wt %.

FIG. 15 shows a temperature sweep rheology plot showing gel-sol transition of 10% PAAm 150 kDa gel in CCH. Inset shows pictures of gel-to-sol transition from vial inversion.

FIGS. 16A-B show (FIG. 16A) Heat of fusion and (FIG. 16B) melting temperature as a function of polymer concentration for PAAm (6000 kDa) and PAAm 150 kDa in CCH.

FIG. 17 shows a 3D plot showing tan δ at 40° C. obtained from temperature sweep rheology experiments for PAAm, PVA/borax, and hybrid salogels. Note that the borax scale reads from 10 to 0 here to enable easy visibility of the data points with low tan & values.

FIGS. 18A-B show temperature sweep rheology plots showing the effect of polymer concentration (3% and 4%) in (FIG. 18A) hybrid salogel (PAAm: PVA 50:50 by weight) and (FIG. 18B) PVA salogels. Borax concentration is 5 mol % in both FIG. 18A and FIG. 18B.

FIG. 19 shows temperature sweep rheology plots showing G′ and G″ as a function of temperature for different borax concentrations for (FIG. 19A) PAAm salogels and (FIG. 19B) PVA salogels.

FIGS. 20A-C show a temperature sweep rheology plot comparing (FIG. 20A) PAAm, (FIG. 20B) PVA/borax, and (FIG. 20C) PVA/borax/PAAm hybrid salogel at matched total polymer concentration of 4% and borax concentration of 5 mol % to PVA hydroxyl groups.

FIGS. 21A-B show (FIG. 21A) temperature sweep rheology plots showing the PAAm, PVA/borax, and PAAm/PVA/borax hybrid salogels. Note that PVA/borax and PAAm salogels contain 2% polymer, and the hybrid salogel contains 4% polymer (equal amounts of PVA and PAAm). FIG. 21B shows vial inversion experiments showing shape stabilization capability of PAAm, PVA/borax, and hybrid salogel at 25° C.

FIG. 22 shows DSC curves showing melting and crystallization peaks of CCH in 2% PAAm/2% PVA/borax 10 mol % hybrid salogel before and after 50 melting/crystallization cycles.

FIGS. 23A-D show hybrid salogel (2% PAAm/2% PVA/borax 10 mol %) in hexagon shape showing shape stabilization and leakage prevention of CCH. FIG. 23A and FIG. 23C show salogel with CCH in crystallized state. FIGS. 23B and 23D show salogel with CCH in melted state.

FIG. 24 is a schematic showing an embodiment of the present disclosure, PCM storage in plastic-encapsulated thin (high rate of heat absorption) storage slabs. PCM slabs are placed in a storage tank in parallel next to an HVAC/evaporator unit. Each individual slab is 5-10 mm thick and contains an inert, rigid support structure within impermeable plastic encapsulation.

FIG. 25 is a flowchart showing steps involved in hybrid salogel preparation.

### DETAILED DESCRIPTION

The present disclosure provides for a hybrid salogel, methods of making hybrid salogels, and systems using hybrid salogels.

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, inorganic chemistry, synthetic chemistry, and the like, which are within the skill of the art. Such techniques are explained fully in the literature.

The following description and examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar or psig. Standard temperature and pressure are defined as 25° C. and 1 bar.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Definitions

By “chemically feasible” is meant a bonding arrangement or a compound where the generally understood rules of organic structure are not violated. The structures disclosed herein, in all of their embodiments are intended to include only “chemically feasible” structures, and any recited structures that are not chemically feasible, for example in a structure shown with variable atoms or groups, are not intended to be disclosed or claimed herein. However, if a bond appears to be intended and needs the removal of a group such as a hydrogen from a carbon, the one of skill would understand that a hydrogen could be removed to form the desired bond.

It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, elimination, etc.

“Polymers” are understood to include, but are not limited to, homopolymers, copolymers, such as for example, block, graft, random and alternating copolymers, terpolymers, etc. and blends and modifications thereof.

As used herein, “alkyl” or “alkyl group” refers to a saturated aliphatic hydrocarbon, which can be straight or branched, having 1 to 40, 1 to 20, 1 to 10, or 1 to 5 carbon atoms, where the stated range of carbon atoms includes each intervening integer individually, as well as sub-ranges. Examples of alkyl groups include, but are not limited to, methyl, ethyl, n-propyl, i-propyl, n-butyl, s-butyl, t-butyl, n-pentyl, and s-pentyl. Reference to “alkyl” or “alkyl group” includes unsubstituted and substituted forms of the hydrocarbon moiety.

As used herein, “halo”, “halogen”, or “halide”, refers to a fluorine, chlorine, bromine, iodine, and astatine, and radicals thereof. Further, when used in compound words, such as “haloalkyl” refers to an alkyl or alkenyl radical in which one or more hydrogens are substituted by halogen radicals.

The term “unsaturated” refers to a molecule, such as a hydrocarbon or hydrocarbon moiety that includes one or more double bonds and/or triple bonds.

“Aryl”, as used herein, refers to C₅-C₂₀-membered aromatic, heterocyclic, fused aromatic, fused heterocyclic, biaromatic, or bihetereocyclic ring systems. In an aspect, “aryl”, can include 5-, 6-, 7-, 8-, 9-, and 10-membered single-ring aromatic groups that may include from zero to four heteroatoms, for example, functional groups that correspond to benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics”. The aromatic ring can be substituted at one or more ring positions with one or more substituents including, but not limited to, halogen, azide, alkyl, aralkyl, alkenyl, alkynyl, cycloalkyl, hydroxyl, alkoxyl, amino (or quaternized amino), nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN; and combinations thereof.

The term “aryl” also includes polycyclic ring systems (C₅-C₃₀) having two or more cyclic rings in which two or more carbons are common to two adjoining rings (i.e., “fused rings”) wherein at least one of the rings is aromatic, e.g., the other cyclic ring or rings can be cycloalkyls, cycloalkenyls, cycloalkynyls, aryls and/or heterocycles. Examples of heterocyclic rings include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl, 1,2,3-triazole, 1,2,4-triazole and xanthenyl. One or more of the rings can be substituted as defined above for “aryl”.

In some aspects, a structure of a compound can be represented by a formula:

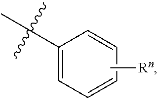

which is understood to be equivalent to a formula:

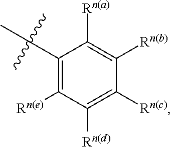

where n is typically an integer. That is, Rⁿ is understood to represent five independent substituents, R^{n(a)}, R^{n(b)}, R^{n(c)}, R^{n(d)}, and R^{n(e)}. By “independent substituents,” it is meant that each R substituent can be independently defined. For example, if in one instance R^{n(a)} is halogen, then R^{n(b)} is not necessarily halogen in that instance.

### General Discussion

The present disclosure provides for a hybrid salogel (also referred to as “shape-stable hybrid salogel”), methods of making hybrid salogels, and systems using hybrid salogels. The present disclosure provides for a hybrid salogel that includes a chloride based PCM, a polymer mixture (e.g., two polymers such as polyvinyl alcohol (PVA) and polyacrylamide (PAAm)), and a crosslinker. In an aspect, the crosslinker can be covalently crosslinked to the polymer mixture. In another aspect, the crosslinker can be dynamically covalently bonded to the polymer mixture. In another aspect, the crosslinker can be non-covalently dynamically bonded to the polymer mixture. In another aspect, the crosslinker can be ionically crosslinked to the polymer mixture. The hybrid salogel with the polymer mixture can form a gel in the chloride salt hydrate through its hydrogen bonding network and entanglements with T_{gel} greater than 85° C. For example, combining PVA and PAAm in different ratios and using borax, for example, as a crosslinker enabled a synergistic combination of the properties of stabilizing polymers, yielding hybrid salogels with tunable T_{gel} in a workable temperature range (30-80° C.) (as well as T_{gel} range (7-75° C.)) with <5% total polymer. The moldability and shape stability of the hybrid thermo-reversible salogels has been demonstrated by making different shaped molds that showed leakage prevention and shape stabilization above the melting point of the chloride salt hydrate. The hybrid salogels also showed excellent retention of mechanical and thermal properties after 50 melting/crystallization cycles along with a 30° C. reduction in degree of supercooling, another problem with salt hydrates that is typically solved using nucleation agents. Additional details are provided in Example 1 and Example 2.

The present disclosure provides a shape stabilizing strategy (e.g., shape-stable hybrid salogel) that is low-cost chloride salt hydrate PCM using a hybrid polymer gel system (e.g., polymer mixture) that includes very low polymer amounts (<5%) (e.g., hybrid salogel). The hybrid polymer system confers temperature reversibility to the hybrid salogel and the transition temperature can be controlled by varying the composition of the polymer mixture. The temperature at which the material undergoes debonding can be widely tuned by varying the polymer composition. The temperature reversibility of the hybrid salogel allows the material to be molded into different shapes and can also be filled and removed from heat exchange modules at the beginning or end of their life cycle. In addition, the hybrid salogel showed potential to reduce supercooling, another problem with inorganic salt hydrate PCMs which is usually solved using inorganic particles working as nucleation agents. The present disclosure allows for controlling and tuning the gel-to-sol transition temperature while achieving shape stabilization below this temperature in the liquid state of the salt hydrate phase change material.

In an aspect, the temperature reversibility of the hybrid salogel allows it to be molded into different shapes and can be filled into a variety of molds and removed. In one aspect, the hybrid salogel can be a commercial product that may be sold to customers who can fill them into molds or heat exchangers as desired. In another aspect, the hybrid salogel can be used in various heat exchanger type systems and the heat exchanger systems containing the hybrid salogel can be sold as a commercial product. In an aspect, the hybrid salogels can be disposed into thin-walled plastic containers that allow for adequate heat transfer within a heat exchanger.

As described above, the present disclosure provides for a hybrid salogel that includes a PCM, a polymer mixture, and a crosslinker. The polymer mixture can include two or more polymers (e.g., a first polymer and a second polymer). In an aspect, the hybrid salogel can include about 94 to 99 weight percent of the PCM. In an aspect, the hybrid salogel can include about 0.2 to about 5 weight percent of the polymer mixture. In an aspect, the hybrid salogel includes about 0.1 to 0.5 weight percent of the crosslinker.

The polymer mixture can include a first polymer and a second polymer. In an aspect, the first polymer can be about 10 to 90 parts by weight, about 40 to 60 parts be weight, or about 50 parts by weight. In an aspect, the second polymer can be about 10 to 90 parts by weight, about 40 to 60 parts by weight, or about 50 parts by weight.

In an aspect, the first polymer can be polyvinyl alcohol (PVA) or a homopolymer containing hydroxyl groups, including poly(hydroxyethyl methacrylate) (PHEMA), poly(2-hydroxyethyl acrylate) (PHEA), or copolymers of vinyl acetate (VA), hydroxyethyl methacrylate (HEMA), and/or hydroxyethyl acrylate (HEA). In an aspect, the PVA can have a molecular weight from 10,000-15,000 g/mol.

In an aspect, the second polymer can be polyacrylamide (PAAm), its block or random copolymers, as well as a polymer containing amide or amine groups. In an aspect, the PAAm can have a molecular weight of at least 1,000,000 g/mol. The first and second polymers are different polymers.

In other embodiments the first and/or second polymer can include or be mixtures of other polymers: neutral, polar polymers containing: carboxylic acid groups—at least two functional groups but preferably on every monomer unit (for example, polyacrylic acid, polymethacrylic acid, or sodium salt of polyacrylic acid); amine functional groups—at least two functional groups but preferably on every monomer unit (for example, polyvinyl amine, polyallylamine, poly(n-methyl vinylamine), polyethyleneimine (PEI), or chitosan); hydroxyl functional groups—at least two functional groups but preferably on every monomer unit (for example, any homopolymers containing hydroxyl groups, such as polyvinyl alcohol, poly(hydroxyethyl methacrylate) (PHEMA), poly(2-hydroxyethyl acrylate) (PHEA), chitosan, or copolymers of VA, HEMA, and/or HEA); amide functional groups—at least two functional groups but preferably on every monomer unit (for example, polyacrylamide (PAAm), copolymers of polyacrylamide and polyacrylic acid, copolymers of polyacrylamide and sodium polyacrylate); polyethylene glycol having a molecular weight from 200-35,000 g/mol, or polyethylene oxide having a molecular weight from 100,000-8,000,000 g/mol.

The PCM can include inorganic salt hydrate, mixtures of inorganic salt hydrates, and eutectic mixtures or other non-eutectic mixtures. In an aspect, the PCM can include chloride salt hydrate or a mixture of chloride salt hydrates. The PCM can be a stoichiometric chloride hydrate (e.g., CaCl₂·6H₂O, MgCl₂·6H₂O, LiCl·H₂O, MnCl₂·4H₂O), and mixtures thereof (e.g., CaCl₂·6H₂O—MgCl₂·6H₂O, CaCl₂·6H₂O—MnCl₂·6H₂O), including eutectic mixtures; mixtures of chloride hydrates optionally including anhydrous chlorides (e.g., NaCl, KCl, NH₄Cl), including eutectic mixtures; stoichiometric nitrate hydrates (e.g., LiNO₃·3H₂O, Mg(NO₃)₂·6H₂O, Ca(NO₃)₂·4H₂O, Zn(NO₃)₂·6H₂O, Fc(NO₃)₂·9H₂O), and mixtures thereof (e.g., LiNO₃·3H₂O—Zn(NO₃)₂·6H₂O, Mg(NO₃)₂·6H₂O—Zn(NO₃)₂·6H₂O), including eutectic mixtures; mixtures of nitrate hydrates and anhydrous nitrates (e.g., NaNO₃, KNO₃, NH₄NO₃), including eutectic mixtures; stoichiometric sulfate hydrates (e.g., Na₂SO₄·10H₂O, Al₂(SO₄)₃·18H₂O, MgSO₄·7H₂O), and mixtures thereof (e.g., Na₂SO₄·10H₂O—MgSO₄·7H₂O), including eutectic mixtures; mixtures of sulfate hydrates and anhydrous sulfates, including eutectic mixtures; other inorganic salt hydrates such as CaBr₂·6H₂O; and mixtures of salt hydrates with different anions (e.g., CaCl₂·6H₂O—Ca(NO₃)₂·4H₂O, CaCl₂·6H₂O—CaBr₂·6H₂O), including eutectic mixtures.

In an aspect, the crosslinker can include at least two functional groups (e.g., difunctional compounds) either of the same type or a combination of two or more types (e.g., an aldehyde with a boronic acid (4-formyl phenyl boronic acid), isocyanate with a silane (isocyanatopropyl triethoxysilane)). The crosslinker should be able to crosslink one of the two polymers in the polymer mixture. In an aspect, the crosslinker can crosslink between the two polymers in the polymer mixture. One or more crosslinkers can be used. In an aspect, the crosslinker can form bonds that are strong enough to provide shape stabilization and prevent leakage of salt hydrate PCM from the salogel but also be reversible by heating above a gel-to-sol transition temperature so that the salogel can be processed into different forms.

The crosslinker can include borax type crosslinkers and other crosslinkers that form crosslinks similar to borax (e.g., boronic acids, chromates, antimonates, titanates). In an aspect, the crosslinker can be: sodium tetraborate decahydrate (borax), Na₂B₄O₇·10H₂O; anhydrous borax, Na₂B₄O₇, boric acid, H₃BO₃, sodium metaborate, NaBO₂, sodium perborate, Na₂B₂O₄, zinc borate, 2ZnO·3B₂O₃·3.5H₂O, ammonium pentaborate tetrahydrate, NH₄B₅O₈·4H₂O, disodium tetraborate pentahydrate, Na₂B₄O₇·5H₂O, sodium tetraborate pentahydrate, Na₂B₄O₇·5H₂O, disodium octaborate tetrahydrate, Na₂B₈O₁₃·4H₂O, potassium pentaborate tetrahydrate, KB₅O₈·4H₂O, potassium tetraborate tetrahydrate, K₂B₄O₇·4H₂O, sodium pentaborate, NaB₅O₈·5H₂O, sodium metaborate dihydrate, Na₂B₂O₄·4H₂O, sodium metaborate tetrahydrate, Na₂B₂O₄·8H₂O, dicalcium hexaborate pentahydrate, 2ZnO·3B₂O₃·5H₂O, tetrahydroxy diboron, 1,4-phenylene diboronic acid, 4-formyl phenyl boronic acid, pyridine-4-boronic acid, titanates such as tri (dioctylpyrophosphoryloxy) isopropyl titanate, chromates such as chromic nitrate, and antimonates such as potassium pyroantimoniate. In an aspect, the crosslinker can include crosslinkers that are capable of forming hydrogen bonds with polyvinyl alcohol (PVA) such as: congo red, resorcinol, polyamidoamine dendrimers, and other hydrogen bonding polymers and molecules containing at least two amine, amide, amidoamine, carboxylic acid and/or other hydrogen bonding functional groups. In an aspect, the crosslinker can include other crosslinkers for PVA such as difunctional aldehydes such as glutaraldehyde, silane crosslinkers-crosslinkers containing two or more silane functional groups such tetraethyl orthosilicate, and isocyanates-such as hexamethylene diisocyanate, isophorone diisocyanate, toluene diisocyanate, pentamethylene diisocyanate. In an aspect, the crosslinker can include crosslinkers for polyacrylamide (PAAm) such as difunctional aldehydes such as glutaraldehyde, hydrogen bonding polymers and molecules containing hydroxyl, carboxylic acid, amine, amidoamine, and other functional groups capable of hydrogen bonding, diisocyanates-such as hexamethylene diisocyanate, isophorone diisocyanate, toluene diisocyanate, pentamethylene diisocyanate, and difunctional epoxies-neopentyl glycol diglycidyl ether, diglycidyl ether of bisphenol A, diglycidyl ether of bisphenol F.

In general, the present disclosure provides for a structure that includes a hybrid salogel as described herein. In an aspect, the structure can be: a storage slab, a storage sheet, a storage pouch, a plate-fin heat exchanger, a shell and tube heat exchanger, a finned tube heat exchanger, a spiral tube heat exchanger, cement, concrete, brick, cinder block, drywall, ceiling tiles, flooring, a textile, and a fabric.

In general, the present disclosure provides for a PCM storage structure that includes at least one encapsulated thin storage slab in a storage tank. The at least one encapsulated storage slab could include an inert rigid support structure for further mechanical rigidity and a hybrid salogel. In general, the present disclosure provides for a PCM storage structure that includes at least one PCM filled heat exchanger enclosure. The thermos-reversible hybrid salogel is heated above the melting point and filled in the liquid state, after which subsequent melting and crystallization occurs within the hybrid salogel.

In an aspect, hybrid salogels (also referred to as “shape-stable hybrid salogels”) can be used to reduce (e.g., about 90% or more) or avoid (e.g., about 98-100%) flowing and redistribution of the hybrid salogel (including the (PCM)) within an enclosed heat exchanger. In contrast, current PCMs melt to a liquid, which results in gravitationally-driven flow and accumulation of PCM in the bottom of a heat exchanger. Upon melting of the solid (which generally results in a volume expansion in salt hydrate PCMs), this can result in damage and rupture of heat exchanger elements, resulting in loss of PCM and thermal energy storage capacity. The shape-stable hybrid salogel as disclosed herein do not flow and thus are resistant to this damage mode.

In an aspect, use of the hybrid salogels can be used to maintain close thermal contact between a PCM of the hybrid salogel and a heat distribution element. In current technologies, the combination of volume change and gravity-driven flow in liquid PCMs currently used can result in separation of a liquid PCM from a heat exchanger surface (e.g., the top surface of a horizontal tube would lose direct contact with the PCM). Hybrid salogels of the present disclosure do not flow and thus will maintain thermal contact and effective heat transfer between a solid heat distribution element and the PCM.

In particular aspects, the hybrid salogels can be disposed within standard heat exchanger architectures (e.g., plate-fin, shell and tube, finned tube, or spiral tube architectures), which are used in heat exchanger structures.

In an aspect, the PCM can be micro-encapsulated PCM particles. Micro-encapsulation can result in protective barriers around a PCM droplet (generally ranging from microliter to milliliter volumes), allowing for use of PCMs embedded in concrete, within drywall, or incorporated into fabrics. For some micro-encapsulation methods, it is advantageous to form a coating around a solidified shape-stable particle. Hybrid salogels of the present disclosure do not flow, which allows the use of encapsulated PCMs.

In an aspect, hybrid salogels can be used in sheets or slabs in heat exchangers. Heat exchangers serve to increase the heat transfer between a heat transfer fluid (or refrigerant) and another heat transfer fluid or a thermal energy storage medium. As an alternative strategy, the shape-stable hybrid salogels described herein can be used to make shapes that have high surface area to volume ratios (e.g., an array of thin sheets or plates) that allow for direct interaction between the PCM of the hybrid salogel and a heat transfer fluid, thereby eliminating the need for a costly metal heat exchanger. Shape-stable hybrid salogels allow for this strategy to be used.

In particular aspects, hybrid salogels that include macro-encapsulated PCMs can be used in slabs, sheets, or pouches (e.g., about 1 mm to a 5 cm thick, and various lengths and widths). These slabs or sheets can be integrated into walls, ceiling tiles, or flooring, as well as directly into direct-contact heat exchangers, where a fluid or gas flows over or across the slab.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

One of the challenges preventing wide use of inorganic salt hydrate phase change materials (PCMs) is their low viscosity above their melting point leading to leakage, phase segregation, and separation from heat exchanger surfaces in thermal management applications. The development of a broad strategy for using polymers which provide tunable, temperature-reversible shape stabilization of a variety of salt hydrates by using the lowest possible polymer concentrations is hindered by differences in solubility and gelation behavior of polymers with change in the type of ion. This work addressed the challenge of creating robust, temperature-responsive shape-stabilizing polymer gels (i.e., salogels) using a low cost PCM, calcium chloride hexahydrate (CaCl₂·6H₂O, CCH). Due to the extremely high (9 M) concentration of chloride ions and the tendency to salting-out polymer chains, the previous strategy of using single-polymer salogels was not successful. Thus, this work introduced a strategy of using two polymers—poly(vinyl alcohol) and ultra-high molecular weight polyacrylamide (PVA and PAAm, respectively)-along with borax as a crosslinker to achieve temperature-reversible, shape-stable salogels. This system resulted in robust salogels whose gel-to-sol transition temperature (T_{gel}) was tunable within an application-relevant range of gelation temperature (30-80° C.). This behavior was enabled by a synergistic combination of dynamic covalent crosslinks between PVA units and entanglements of PAAm chains which were combined into a single hybrid network. The hybrid salogels had <5 wt % polymer content, maintaining ˜95% of the heat of fusion of the pure PCM. Importantly, the noncovalent nature of gelation supported thermo-reversibility of gelation, shape stability, and retention of thermal properties over 50 melting/crystallization cycles.

### Introduction

Energy and environmental crisis arising from rapid economic growth and over-reliance on fossil fuels has led to a situation of dire need for both alternate energy sources and storage technologies to meet the gap between demand and supply.^{1, 2} Thermal energy storage technologies using phase change materials (PCMs), which can store and release large amounts of energy in the form of latent heat are becoming important in solar thermal energy applications, industrial waste heat recovery, and building thermal regulation.¹⁻³ Incorporation of PCM materials in building walls and thermal energy storage modules allows heat capture and cooling during the day while energy released at night can be used for heating over many cycles.² Among the types of materials used as PCMs in building applications—organic⁴⁻⁷ and inorganic,^{5, 6} inorganic salt hydrates are gaining traction because of their high volumetric latent heat storage capability, low cost, high thermal conductivity, and non-flammability in comparison to their organic counterparts.^{2, 3, 5, 6, 8} Widespread use of salt hydrates has been limited, however, by lack of shape stability of these PCMs in the liquid state due to their low viscosity that makes them susceptible to leakage from thermal energy storage modules.^{2, 3, 9}

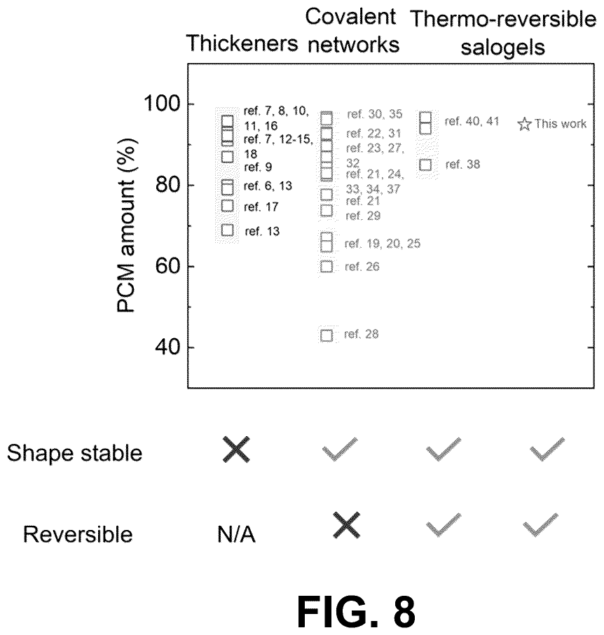

Shape stabilization strategies for salt hydrates PCMs can be broadly classified into three categories: encapsulation, impregnation in a porous matrix, and entrapment in organic three-dimensional network structures.⁹ In addition, polymer thickeners, which increase the viscosity of the salt hydrates, are often added to molten PCMs to prevent phase segregation. However, the relatively large amounts (5-25% by weight) of the added thickeners reduce the PCM content decreasing the heat storage capability. Moreover, polymer thickeners do not provide shape stabilization or prevent leakage of molten PCMs (FIG. 8).¹⁰⁻²³ In contrast, covalently crosslinked polymer gels which also often require large polymer amounts (5-60% by weight), provide shape stabilization (FIG. 8).²⁴⁻⁴⁰ However, the permanent nature of the crosslinks render these materials irreversible making filling and removal from thermal energy storage modules impossible.

Changing the ion in the inorganic salt hydrate can result in very different properties resulting in some compositions being deficient and unusable due to solubility and gelation behavior. For example, changing from nitrate based inorganic salt hydrates to chloride based inorganic salts can produce defective products. In addition, including crosslinkers with a polymer and certain inorganic salt hydrates can also result in defective products, such as having drastic reduction in the gel strength and gel-to-sol transition temperature (T_{gel}) range.

In contrast to these previous strategies, our group introduced temperature-responsive polymer salogels (polymer gels in inorganic salt hydrates) based on hydrogen bonding polymers such as poly(vinyl alcohol) (PVA), for reversible shape stabilization of liquid salt hydrates.^{41, 42} The on-demand reversibility of gelation by heating above a gel-to-sol transition temperature (T_{gel}) allows filling and removal of the salogels from thermal energy storage devices, whereas gelation below T_{gel} provides shape stabilization above melting temperature of the salt hydrate (Tₘ). Note that such on-demand reversibility is not possible with either encapsulation or impregnation methods because both types of matrices lack temperature-triggered reversibility.

Our prior work demonstrated that hydrogen bonding polymers form gels in liquid inorganic salt hydrates because of the unique behavior of salt hydrate solvents where the high ionic concentration and scarcity of water result in incomplete saturation of hydration shell of ions.^{41, 42} This causes dehydration of polymer chains due to competition between the ions and polymers for the water in the salt hydrate, inducing polymer-polymer and polymer-ion interactions that facilitate gelation of PVA at relatively low polymer concentrations (5-15 wt % in LiNO₃·3H₂O (LNH) and Ca(NO₃)₂·4H₂O (CNH)),^{41, 42} at which PVA gels do not form in aqueous solutions. The developed salogels provided shape stabilization of the nitrate salt hydrates above the PCM melting temperature but could still reversibly revert to a liquid by temperature-induced dissociation of the hydrogen bonded polymer network at a gel-to-sol transition temperature, T_{gel}. The addition of hydrogen bonding and dynamic covalent crosslinkers allowed further strengthening of the salogel and tunability of T_{gel} over a wide temperature range by varying the crosslinker concentration.^{43, 44} These strategies allowed us to create salogel systems for nitrate salt hydrates with high PCM loading (>90 wt %) enabling retention of thermal energy storage capability while simultaneously providing efficient shape stabilization and on-demand reversibility of gelation to enable filling and removal. A comparison of salogels with thickeners and covalent networks based on PCM amounts reported in literature is provided in FIG. 8.

In this work we explore salogel systems in a different, chloride-based PCM—calcium chloride hexahydrate (CaCl₂·6H₂O, CCH). CCH has low toxicity and is economical compared to lithium based salt hydrates as it is generated as a waste by-product in chemical processes such as soda ash production, and is also naturally abundant.^{8, 45, 46} In addition, a melting temperature of 29° C. and heat of fusion of 190 J/g make this salt hydrate ideal for thermal energy storage applications in waste heat recovery, textiles, and buildings.^{8, 40, 46} Shape stabilization of CCH by impregnation in a porous matrix⁴⁷⁻⁵⁰ or encapsulation^{51, 52} has been demonstrated but these approaches lack temperature-triggered reversibility and also result in a significantly reduced heat of fusion compared to that of neat CCH. Similarly, the use of polymer thickeners for CCH,^{21, 23} or permanently crosslinked networks for CCH—MgCl₂·6H₂O eutectic⁴⁰ lacks the desired shape stabilization and temperature reversibility. Here, we address the challenge of thermo-reversible shape stabilization of CCH by introducing the hybrid salogel strategy. The novel strategy was necessary as the switch from nitrate (CNH) to chloride (CCH) salt hydrate resulted in drastic changes in the gelation behavior of PVA so that strong and temperature responsive salogels could no longer be prepared at low polymer concentrations (˜3-4 wt %) using our previous strategy involving a single polymer network based on PVA/borax dynamic covalent bonding.⁴⁴

Hence, we introduce a strategy of making a hybrid salogel system where the polymer networks are formed at low total polymer concentrations (<5 wt %) by synergistic effect of intermolecular hydrogen bonding between PVA and ultra-high molecular weight polyacrylamide (PAAm, 6000 kDa). The PVA and PAAm are further reinforced by boronate ester bonds and entanglements, respectively. The resulting hybrid network comprising boronate ester bonds, and entanglements works synergistically in a single network to provide shape stabilization and leakage prevention of CCH. The thermo-reversible nature of all these interactions supports tunable temperature response and retention of thermal properties of CCH in the salogel even after repeated thermal cycling.

### Materials and Methods

### Materials

PVA (molecular weight 90 kDa, 98% hydrolyzed) and sodium tetraborate decahydrate (borax) (ACS, 99.5-105.0%) were purchased from Alfa Aesar and used without modification. Calcium nitrate tetrahydrate (ACS, 99.0-103.0%) and anhydrous calcium chloride (96%) were purchased from Alfa Aesar and used without modification. Deuterium oxide (D₂O) with 99.9 atom % and polyacrylamide (6000 kDa and 150 kDa) were purchased from Sigma-Aldrich and used as received. Calcium chloride hexahydrate (CCH), CaCl₂·6H₂O (99%, calculated based on dry substance), was obtained from Sigma Aldrich, and was used as received.

### Preparation of Salogels

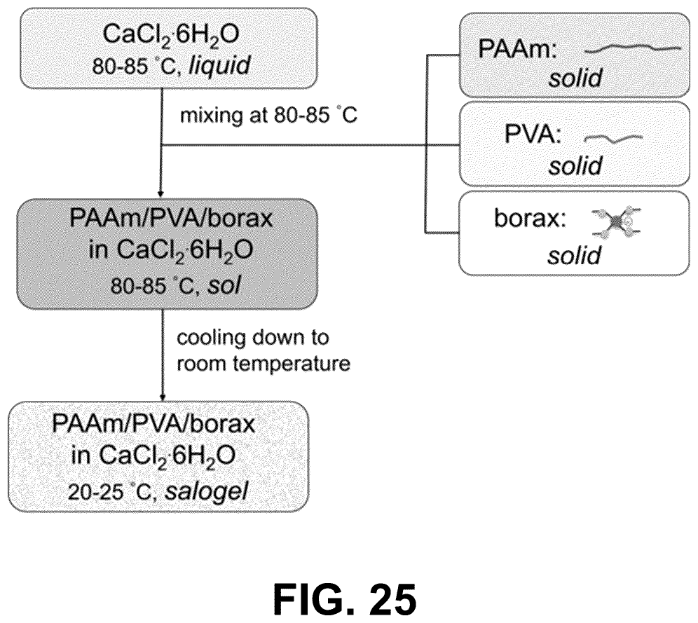

Salogels were prepared by adding a solid polymer (PVA and/or PAAm) into liquid chloride salt hydrate (CCH) with gentle stirring and heating at 80° C. on a hot plate in a sealed vial until the polymers dissolved. Both PVA and PAAm dissolved in CCH in about 24 hours of mixing at 80° C. The polymer-CCH mixture was removed from the hot plate and placed in an oven at 80° C. overnight to remove bubbles and obtain a homogeneous solution which was cooled down to room temperature to induce gelation to form borax-free salogels. Borax containing salogels were prepared by adding borax (amount calculated as mol % of borax to PVA hydroxyl groups) to the polymer-CCH mixture followed by heating the mixture to 85° C. for 24 hours while stirring to facilitate the dissolution of borax. Once the borax dissolved, the polymer-borax-CCH mixture was removed from the hot plate and put in an oven at 85° C. overnight to remove air bubbles. The homogeneous mixture obtained was then cooled down to room temperature to induce gelation. Salogel preparation flowchart is shown in FIG. 25. Because of the known supercooling effect that is significant in the case of CCH,⁴⁰ no crystallization occurred in the salogel systems at room temperature. However, crystallization occurred at refrigeration temperature of 4° C. in a few hours in contrast to CNH salogels reported in our previous work which required freezing temperatures for several hours.⁴⁴

### Deuteration of CNH and CCH for ATR-FTIR Studies

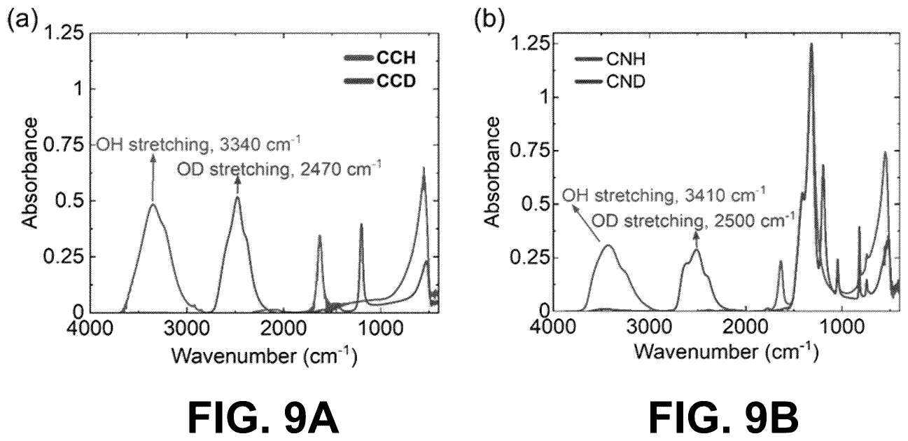

The use of deuterium oxide (D₂O) in place of H₂O in salogels enabled distinguishing the —OH stretching band of water from the salt hydrates from the —OH stretching band of PVA and observing the —NH band in PAAm (3200-3350 cm⁻¹). To prepare the deuterated analogue of CCH, i.e. CCD, anhydrous calcium chloride was mixed with the stoichiometric amount of D₂O (moles of water per mole of anhydrous salt, n=6) to obtain CCD. Analysis by attenuated total reflection Fourier transform infrared spectroscopy (ATR-FTIR) showed the disappearance of —OH peak (3000-3800 cm⁻¹) and the appearance of —OD peak (2100-2800 cm⁻¹) after the completion of the above procedure, thus confirming the successful deuteration of CNH (FIG. 9). Deuterated CNH (CND) was prepared using the procedure described in our previous work.⁴⁴ Briefly, CNH was dried in a vacuum oven at 135° C. to remove the water of crystallization to obtain anhydrous calcium nitrate. Anhydrous calcium nitrate was then mixed with stoichiometric amount of water (moles of water per mole of anhydrous salt, n=4) to prepare CND with successful deuteration confirmed from ATR-FTIR (FIG. 9). To study the effect of water concentration on gelation behavior of PVA in the chloride (CCnD) and nitrate (CNnD) salt hydrates, the number of moles of water per mole of anhydrous salt was varied between 4 and 12 by adding appropriate amount of D₂O to the anhydrous calcium chloride and calcium nitrate salts.

### Materials Characterization

ATR-FTIR measurements were performed on a Bruker Tensor II spectrometer equipped with a mercury cadmium telluride (MCT) detector and a single-reflection diamond ATR attachment. Spectra were collected in the range of 400-4000 cm⁻¹ at 4 cm⁻¹ resolutions using 64 repetitious scans. Each measurement was performed with ˜10 μL of sample drop-casted on to the ATR diamond crystal.

Dynamic light scattering (DLS) experiments were conducted in a custom-made instrument using a laser wavelength of 532 nm and a scattering angle of 90°. The samples were filtered through a 0.45 μm PTFE syringe filter before loading into a 12 mm×12 mm plastic cuvette and allowed to equilibrate overnight at room temperature in the cuvette before taking measurements. Measurements were performed at room temperature at PVA concentration of 0.5 mg/mL in both CNH and CCH.

### Rheological Measurements.

Rheological measurements for salogel samples were performed using TA Instruments HR2 Discovery Hybrid Rheometer equipped with a Peltier stage that enabled temperature control within ±0.5° C. All measurements were performed using parallel plate with a 40 mm diameter and a gap of 500 μm. After loading on the rheometer, the salogel samples were initially heated to 80° C. for 5 minutes to remove any thermal history followed by cooling down to room temperature. The samples were allowed to relax for 5 minutes at room temperature to ensure that the gel networks formed completely before beginning the experiments. The linear viscoelastic regime (γ_{L}) was determined by oscillation amplitude sweep experiments conducted at 25° C. within a strain range of 0.1-100% at a frequency of 10 rad/s. The oscillation temperature ramp experiments were performed in the linear viscoelastic regime at a frequency of 10 rad/s and 1% strain by heating the sample from 25° C. to 90° C. T_{gel} was determined from the crossover of storage (G′) and loss (G″) moduli. Water evaporation and absorption during the experiment was minimized using a solvent trap.

### Thermal Analysis.

The thermal properties (melting temperatures and heat of fusion) of neat salt hydrate (without polymer) and in salogels were determined by differential scanning calorimetry (DSC) using a TA Instruments Q2000. Measurements were conducted at a 10° C./min temperature ramp rate from −40° C. to 80° C. under nitrogen gas purging at a flow rate of 50 mL/min. Hermetic aluminum DSC pans were used for all the samples (neat salt hydrate and salogels) and were prepared in a dry box under an inert gas (nitrogen) environment at a controlled humidity of 20% to ensure contamination from ambient moisture was avoided.

### Thermal Cycling and Demonstration of Shape Stabilization of Salogels

The ability of the hybrid salogels to shape stabilize, prevent leakage of CCH, and preserve its thermal properties during thermal cycling was evaluated by subjecting a salogel sample sealed in a 20 mL vial under nitrogen in a dry box to multiple melting and crystallization cycles. Salogels containing 2 wt % PAAm/2 wt % PVA/10 mol % borax were chosen for these experiments. Melting was achieved by heating the vial to 50° C. until all the CCH melted. The vial was then allowed to equilibrate to room temperature and then put in the refrigerator to induce crystallization. DSC scan was performed after 20 cycles by preparing the pan in the controlled humidity, inert environment of the dry box. DSC and rheology experiments were performed after 50 melting/crystallization cycles to test the preservation of thermal and mechanical properties of the salogel. Shape stabilization experiments were performed using hexagon shaped and alphabet shaped (“T”, “A”, “M”, and “U”) salogels obtained by crystallizing the as prepared salogels poured into molds of various shapes after heating above the gel-to-sol transition temperature. Thermal cycling was done by heating the bulk salogels to a temperature (50° C.) above the melting point of CCH (29° C.) while storing the salogel in an air-tight container and holding at this temperature until all the CCH melted.

### Results and Discussion

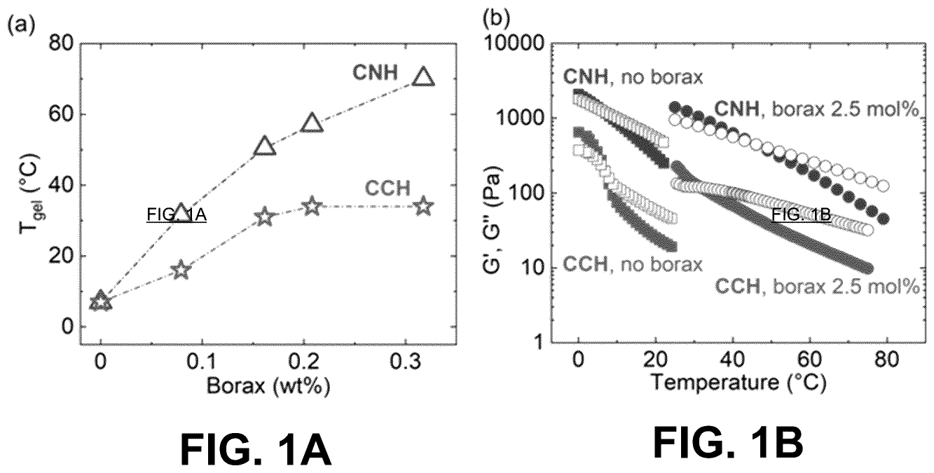

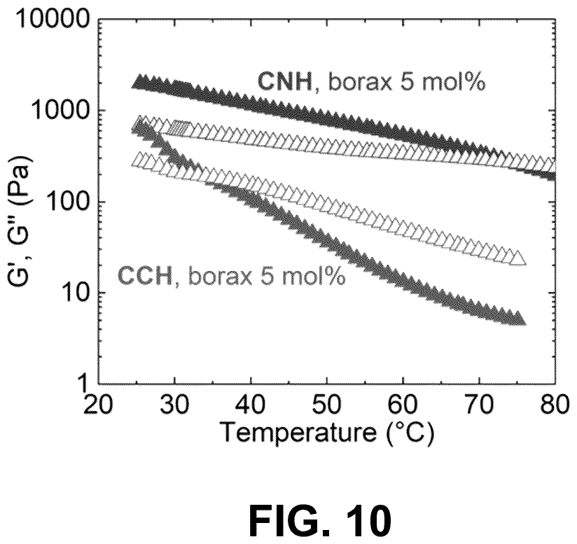

In our previous work we have shown that gelation of PVA in nitrate salt hydrates (CNH and LNH) occurs readily due to the dehydration of polymer chains in the water-scarce environment inducing polymer-polymer and polymer-ion interactions.^{41, 42, 44} Here we focused on a chloride-based PCM (CCH) and first compared the gelation behavior of PVA and the strength of the salogels between a nitrate-based salt hydrate (CNH) and CCH. FIGS. 1 and 10 compare the T_{gel}, and the temperature dependence of G′ and G″ for PVA and PVA/borax salogels in liquid nitrate and chloride salt hydrates. For the same borax concentration, the salogels formed in CNH had higher T_{gel} which could be tuned over a broader temperature range in CNH (7-75° C.) compared to CCH (7-35° C.) (FIG. 1A). Comparison of temperature sweep plots showed that the gels in CCH were weaker compared to the gels in CNH (FIGS. 1B and 10).

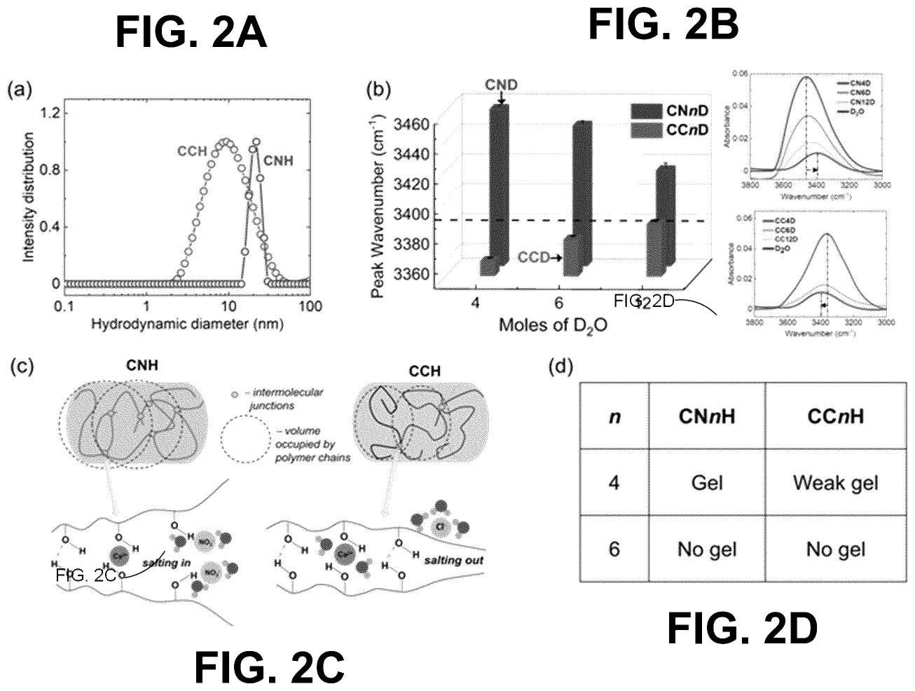

To understand the differences in performance of the salogels formed in different salt hydrates, we aimed to study the behavior of polymer chains by DLS and explore mechanism of gelation of PVA using ATR-FTIR. DLS experiments revealed differences in the hydrodynamic sizes of PVA chains in the liquid CNH and CCH salt hydrates indicating expansion of PVA chains in nitrate-based and more collapsed chains in chloride-based salt hydrate (30 nm and 9 nm, respectively, FIG. 2A). To explore contribution of polymer chain hydration in this behavior, FTIR spectroscopy studies were performed with deuterated salt hydrates (CND and CCD) using a procedure similar to the one used in our previous works.^{42, 44} Deuteration of salt hydrates allowed us to observe the changes in the characteristic wavenumber of the stretching vibrations of PVA hydroxyl group (ν_{OH}^{PVA}) without interference from the hydroxyl group stretching vibrations of H₂O in the salt hydrate (FIG. 9). Note that PVA concentration of 5 wt % was used for ATR-FTIR experiments to increase the intensity of the PVA hydroxyl group peak. Since CNH is a tetrahydrate (n=4, where n is the number of moles of water per mole of anhydrous salt) and CCH is a hexahydrate (n=6), we varied the water content in the salt hydrates to differentiate between the roles of water and nature of ions in solubility and gelation of PVA. The water content was varied from 4 moles per mole of anhydrous salt (lowest water content at which CNH and CCH form stable salt hydrates) to 12 moles (complete saturation of first hydration shell of cation and anion) in both salt hydrates. FTIR analysis of ν_{OH}^{PVA} wavenumber at matched water content (n=4, 6 or 12) for the nitrate and chloride salt hydrate indicated a strong effect of anion type on polymer behavior (FIG. 2B).

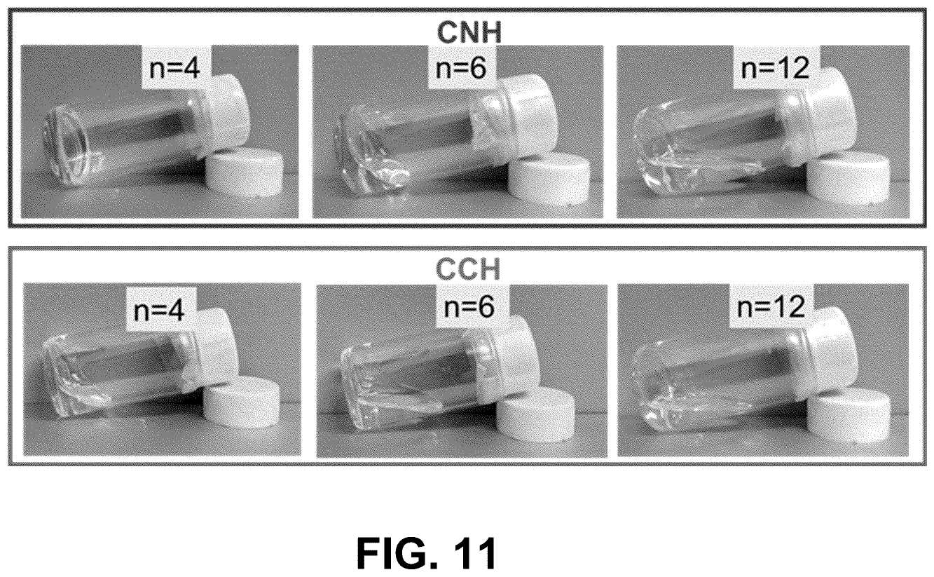

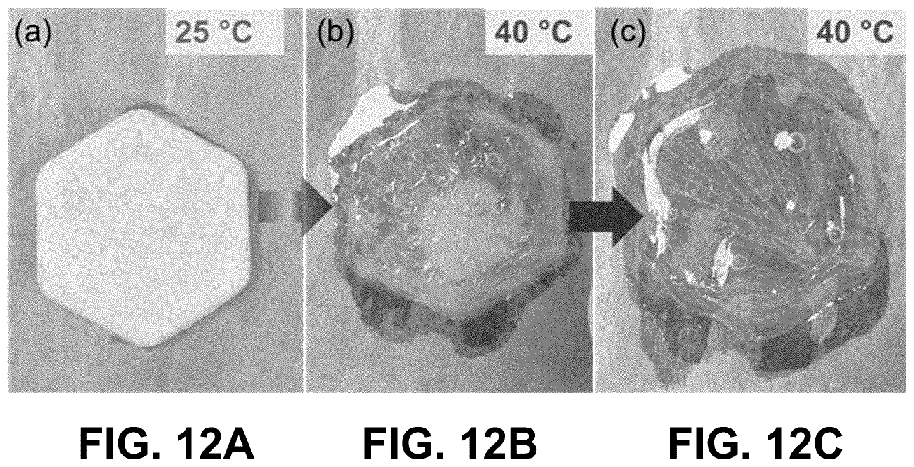

Specifically, compared to bulk water (D₂O) where the wavenumber of the hydroxyl group of PVA was 3393 cm⁻¹, the peak was significantly blue shifted to 3454 cm⁻¹ in CNH and red shifted to 3360 cm⁻¹ in CCH at low water content (n=4 and 6) (FIG. 2B). The peak shift indicates differences in hydrogen bonding state of the hydroxyl group.^{41, 42, 44} These differences can be explained using the Hofmeister effect, which rates anions on a scale based on their ability to cause salting-out (kosmotropes) or salting-in (chaotropes) of polymers in aqueous solutions.^{53, 54} The chaotropic behavior of the nitrate ions results in increased solubility of PVA which disrupt polymer-polymer hydrogen bonding and swell chains as revealed in the strong blue shift of the ν_{OH}^{PVA} (FIG. 2B) and from DLS (FIG. 2A). In contrast, the chloride ions, known to be a transition point from chaotropic to kosmotropic behavior in aqueous solutions,⁵⁵ show strong kosmotropic behavior in the water-scarce salt hydrate environment inducing polymer-polymer hydrogen bonding resulting in a red shift (FIG. 2B) and collapsed polymer chains (FIGS. 2A and 2C). FIGS. 2D and 11 show that PVA (at a concentration of 5 wt %) formed a gel in the nitrate salt at n=4 at room temperature, whereas in the chloride salt no gelation occurred and viscous solution started to flow after a few seconds at room temperature as determined from a simple vial inversion experiment. Therefore, water scarcity and high ionic concentration in salt hydrates has a strong effect on polymer solubility and gelation behavior. The addition of borax did not result in the formation of a strong gel network capable of shape stabilizing and preventing leakage of CCH in the liquid state (FIG. 12). Similar results have been reported for borax complexation with diols in aqueous solutions^{56, 57} and hydrogels^{58, 59} containing NaCl. The decrease in viscosity^{56, 57} and modulus^{58, 59} were rationalized by a charge shielding effect of anionic boronate ester crosslinks by chloride ions leading to enhanced intrachain crosslinking and polymer chain collapse.

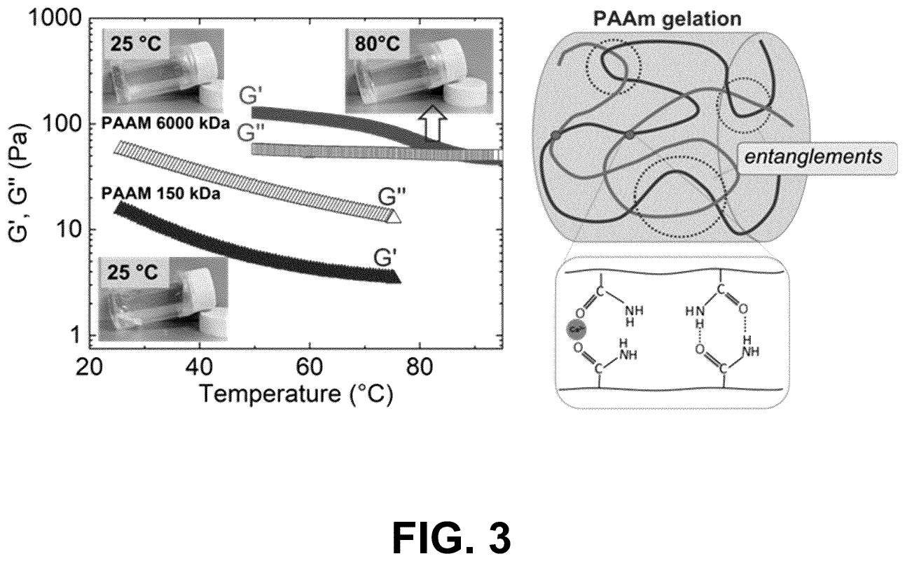

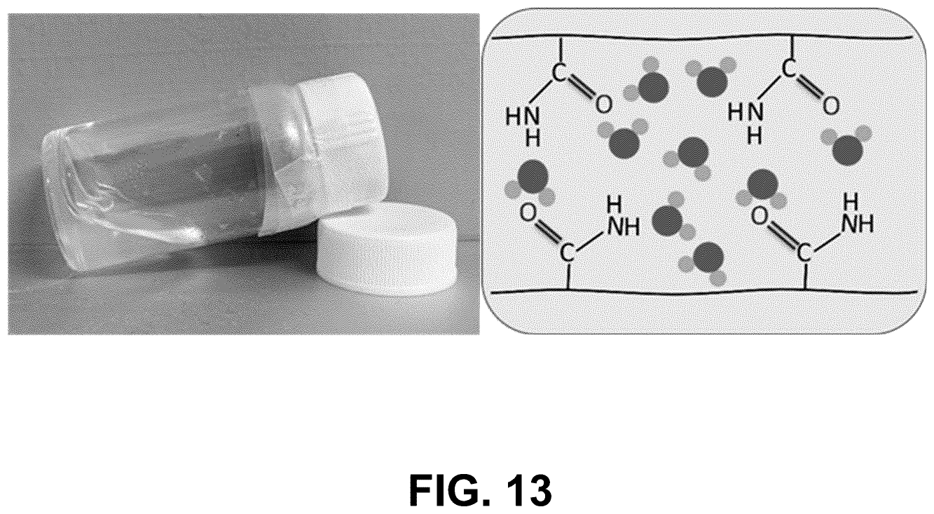

Having understood that PVA/borax system is not sufficient to form strong and shape stable gels in CCH at low polymer concentrations, we aimed to overcome this problem by applying a strategy involving the use of an ultra-high molecular weight polymer which formed a gel network through physical entanglements in addition to hydrogen bonding.⁶⁰ Ultra-high molecular weight polyacrylamide (PAAm) of molecular weight 6000 kDa was used since PVA is not available commercially in this molecular weight range. FIG. 3 shows that PAAm (6000 kDa) formed a physical gel at a low polymer concentration of 3 wt % which was shape stable up to 80° C. but showed reversibility of gelation slightly above this temperature (˜87° C.) due to thermo- responsiveness of entanglements,^{61, 62} while no gelation was observed in water (FIG. 13).

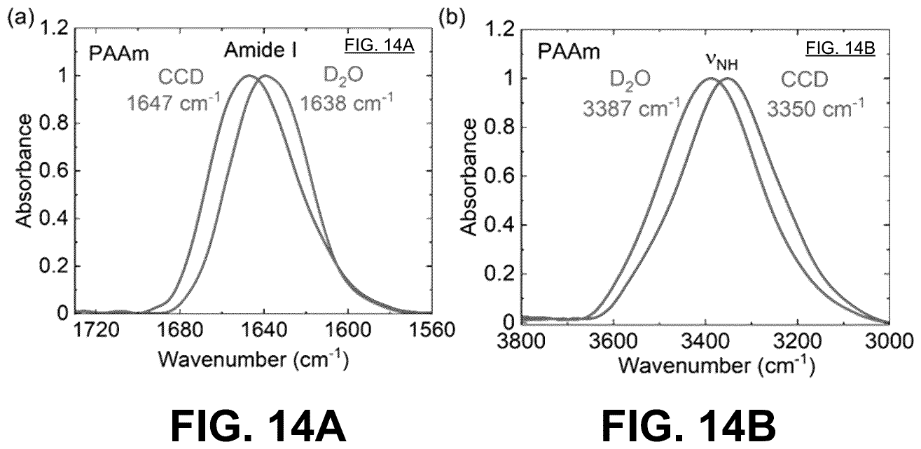

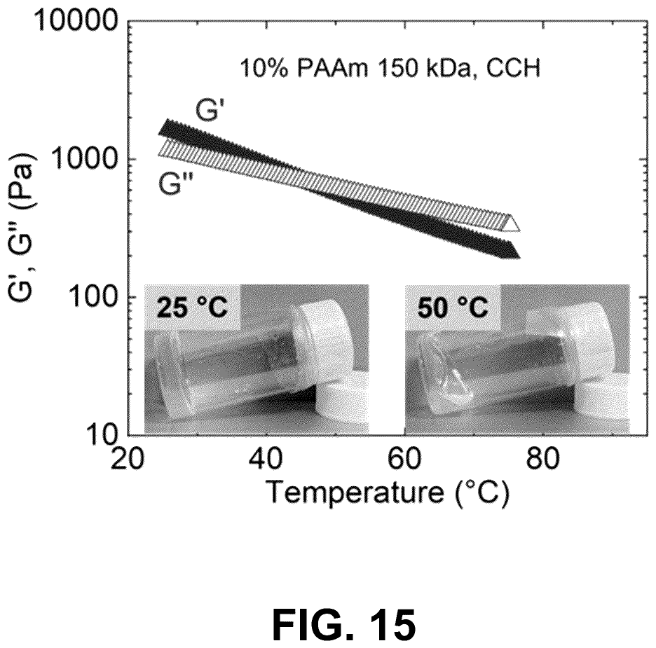

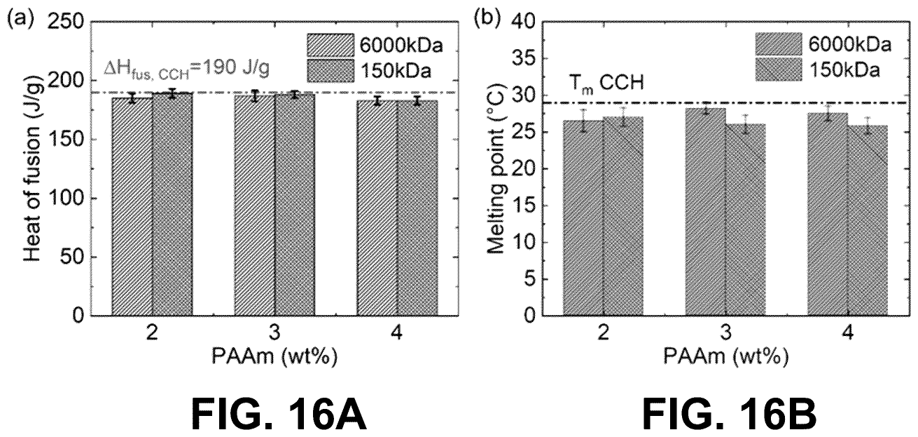

Physical gelation of polymers occurs when the polymer concentration exceeds the overlap concentration (c*) of polymer chains in the solvent.⁶³ Overlap concentration of ultra-high molecular weight PAAm has been reported to be in the range of 0.5-1.6 mg/mL in water for a molecular weight range of 4800-15000 kDa.⁶⁴ Our concentration of 3 wt % (5 mg/mL) in CCH exceeds that significantly resulting in interchain contacts due to entanglements. Based on the molecular weight of PAAm of 6000 kDa and the known entanglement molecular weight for PAAm of ˜400 kDa in water,⁶⁵ number of entanglements forming a polymer network can be estimated as 15 entanglements per chain. In addition to the high number of entanglements, the PAAm network can be further strengthened by intermolecular hydrogen bonding between the amide groups and polymer-ion interactions, both promoted by dehydration of polymer chains in the salt hydrate environment (FIG. 3 schematics). The dehydration of PAAm chains could be detected from the shifts in the amide peaks (salt hydrate vs. aqueous solvents) observed in ATR-FTIR (FIG. 14). In contrast, PAAm of lower molecular weight (150 kDa) was incapable of forming entanglements at low concentration and required as high as 10 wt % polymer concentration to form a temperature reversible gel with a reasonably high T_{gel} of 42° C. (FIG. 15). Within the low range of polymer concentrations (0-4 wt %), PAAms of both molecular weights did not significantly affect the thermal properties (heat of fusion and melting temperature) of the salt hydrate, retaining ˜95% of the heat fusion of CCH and lowering its melting point by only 2° C. for 4 wt % of PAAm concentrations (FIG. 16). However, the use of PAAm 6000 kDa for shape stabilization of CCH was hampered by its relatively high T_{gel} (>90° C.), which was not readily tunable. This high value of T_{gel} makes processing of CCH salogels and filling of heat exchangers difficult, due in part to the relatively high water vapor pressure at this temperature. At the same time, PVA/borax salogels were weak and had low T_{gel} (see FIG. 1). Thus, we pursued the strategy of making hybrid PAAm/PVA/borax salogels in order to combine the advantages of the two systems (PVA/borax and PAAm), which provided a tunable T_{gel} and shape stabilization, respectively.

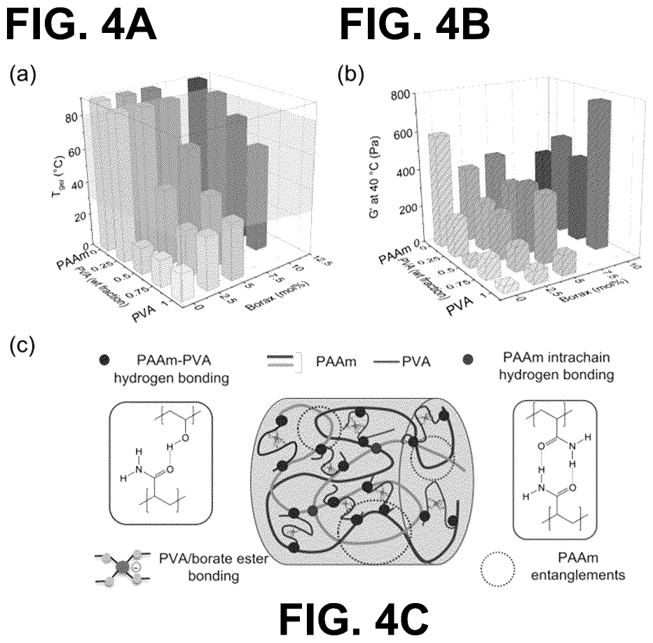

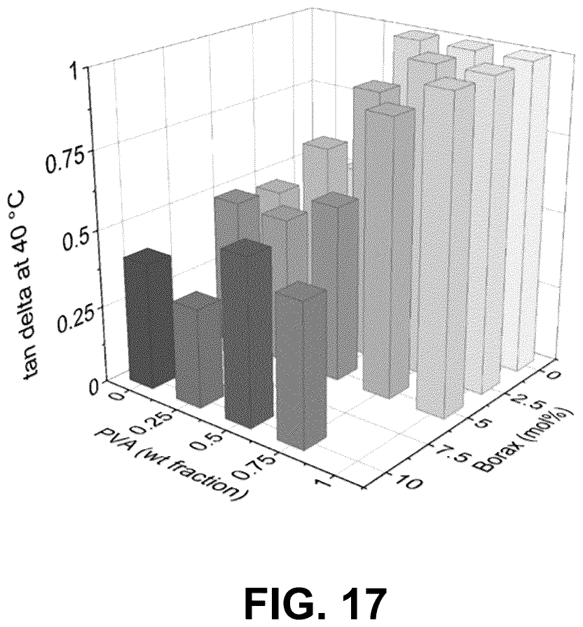

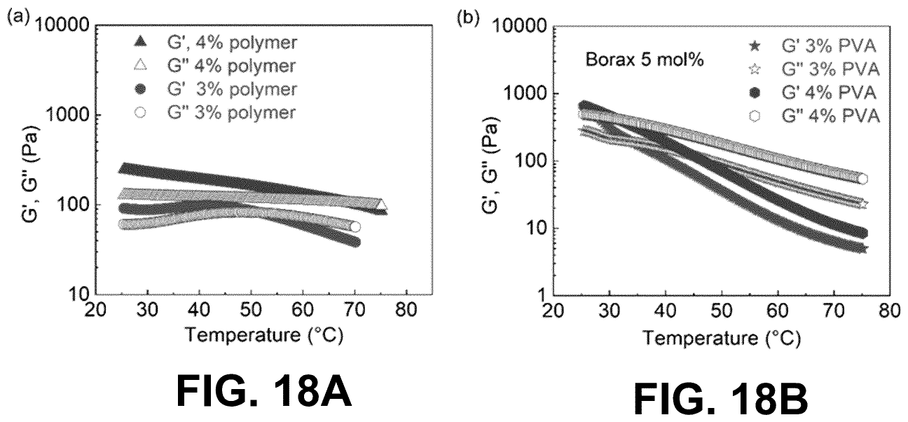

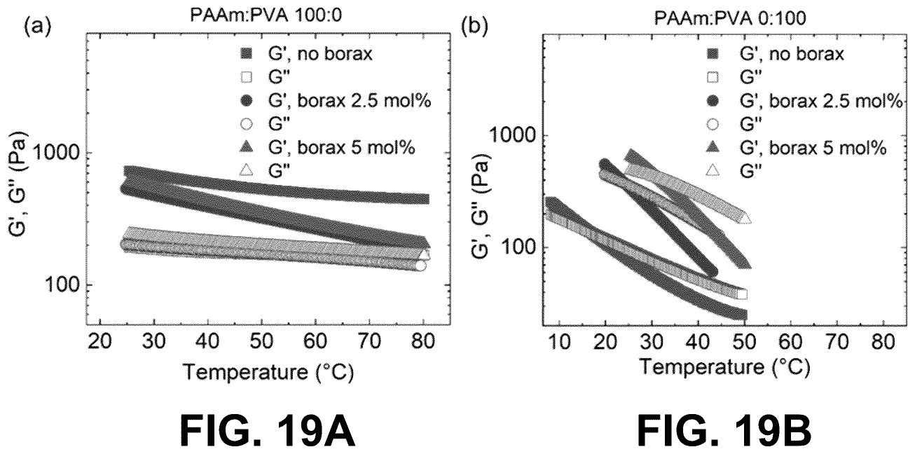

FIG. 4 summarizes the results from temperature ramp rheological experiments performed with salogels of PVA, PAAm, and their hybrids at different polymer weight ratios with and without addition of borax. The various salogel systems were compared on the basis of T_{gel}, and storage modulus (G′) (FIG. 4) and tan δ values (FIG. 17). The G′ values were compared at 40° C. (FIG. 4B), a temperature at which CCH was in its molten state and thus required shape stabilization and leakage prevention. Therefore, a high G′ value and a low tan δ value at this temperature were desirable. Note that the salogel systems shown in FIG. 4 were at 4 wt % total polymer concentration, as an increase in total polymer concentration improved the salogel strength without sacrificing their temperature responsiveness (FIG. 18). Salogels based on PVA/borax system containing only boronate ester bonds had low T_{gel} values and were weak with G′ less than 100 Pa (FIGS. 4A, 4B, 19). On the other hand, salogels based on PAAm were stabilized by physical entanglements and intrachain hydrogen bonding and lacked temperature response in the temperature range of interest. Specifically, T_{gel} values of PAAm salogels were outside of the reliable temperature range of rheological measurements of salt hydrate materials (i.e. >90° C.). (FIG. 4A). Increasing borax concentration did not alter the gelation behavior of PAAm or affected tan δ values measured at 40° C. (FIGS. 4A and 17, respectively), while causing a slight decrease (150-200 Pa) in G′ at 40° C. which may be due to disruption of some intermolecular hydrogen bonds between PAAm by borax (FIG. 4B). The temperature sweep rheology curves for the PAAm/borax salogels are shown in FIG. 19. The data indicate that interactions between PAAm and borax are weak and did not significantly affect the formation of the overall PAAm gel network as there is no change in T_{gel} for the borax concentrations tested.

Combining the two approaches to gelation-entanglements and boronate ester crosslinks-resulted in hybrid salogels with a tunable gelation temperature and mechanical properties. Note that the hybrid salogels showed a single T_{gel} in temperature sweep rheology experiments indicating the formation of a single network. The salogels containing larger amounts of PVA (PVA: PAAm 75:25 by weight) had low T_{gel} range (16-62° C.) due to the predominance of PVA-borax bonds which reverse at a low temperature in CCH (FIG. 1A), while the salogels with larger amounts of PAAm (PVA: PAAm 25:75 by weight) lacked tunability of T_{gel} (FIGS. 4A, 4B, and 17). Hybrid salogels containing equal amounts of PVA and PAAm (PVA: PAAm 50:50) where dynamic covalent crosslinks and entanglements, coupled by PAAm-PVA hydrogen bonds within a joint hybrid network, resulted in the desired combination of T_{gel} tunability and gel strength. Specifically, T_{gel} with tunability over a range of 16-75° C. (FIG. 4A) by varying borax concentration, and addition of borax in the amount of 10 mol % to molar concentration of PVA units yielded salogels with 10× higher G′ and 2× lower tan 8 in comparison to the borax-free counterpart (FIGS. 4B and 17).

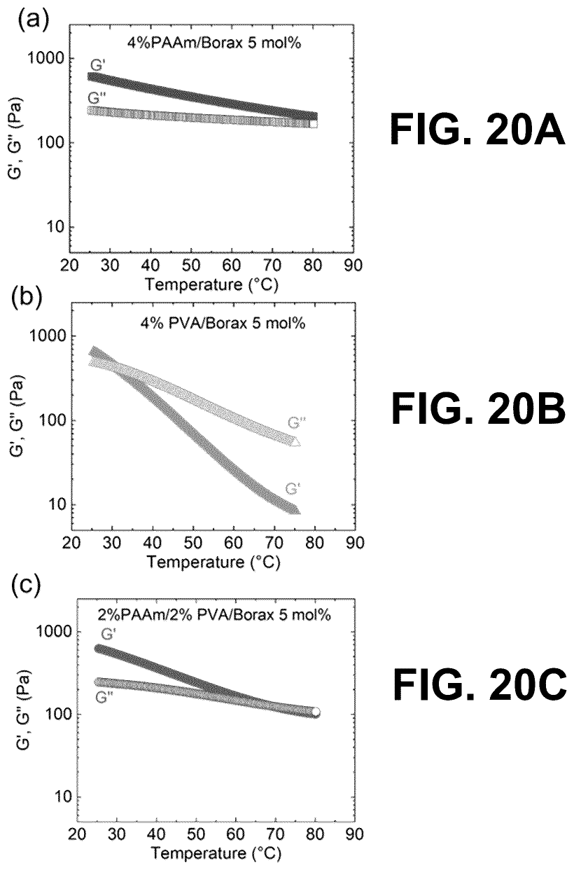

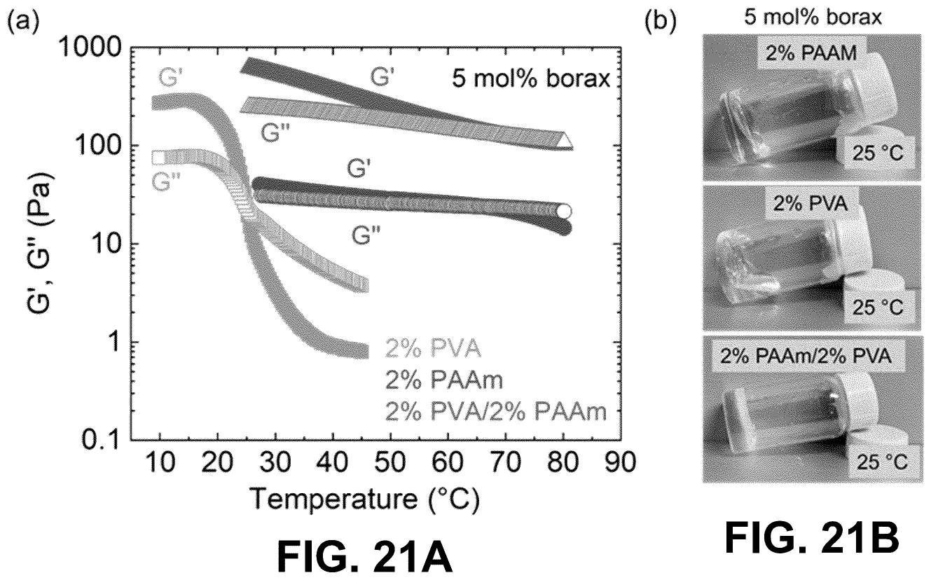

While the salogel with the equal amount of PVA and PAAm with 10 mol % borax had a slightly lower G′ than the 75:25 PVA: PAAm and 25:75 PVA: PAAm, it provided the highest T_{gel} and broadest range of tunability of T_{gel} while maintaining sufficient strength. The improved T_{gel} and mechanical properties is a manifestation of the synergistic effect between the boronate ester crosslinks of PVA units and physical entanglements of PAAm that is enabled by the formation of a network of polymer-polymer hydrogen bonding between PVA and PAAm chains (FIG. 4C) which joined the PVA/borax and PAAm networks together. The synergistic effect of PVA/borax and PAAm is further obvious from comparison of temperature sweep rheology curves of the individual components with the hybrid salogel at matched polymer and borax concentration. While the PVA/borax salogel was not able to shape stabilize CCH, being in the sol state at 40° C., the PAAm salogel was shape stable but had a T_{gel} much higher than 80° C. (FIG. 20). In contrast, hybrid salogels were able to maintain strength while exhibiting temperature responsiveness in the relevant range of temperatures (30 to 80° C.). The contribution of each component in the hybrid salogel can be understood from FIG. 21 where 2% PAAm formed a gel that lacked temperature response in the relevant range of temperatures, while 2% PVA/borax was temperature responsive, with T_{gel} limited to room temperature. When combined, the resulting hybrid network formed by the intermolecular hydrogen bonding between PAAm and PVA enabled a single network with additive effect of entanglements and boronate ester crosslinks resulting in a higher gel strength and T_{gel} which is tunable within a wide temperature range. Therefore, the ability of hydrogen bonds, boronate ester crosslinks, and even entanglements to dissociate and break upon heating supports the temperature response, is important for practical applications as a means for facile removal of a salogel from a heat exchange module at the end of life of a PCM material.

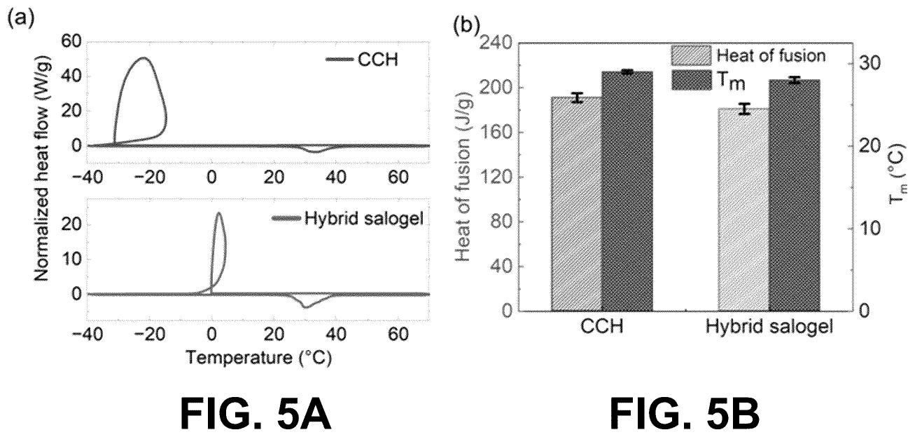

We then aimed to explore thermal energy storage capability of the hybrid salogels during multiple melting and crystallization cycles that is crucial for a long-term use of these materials in thermal energy storage applications. The best-performing salogel system containing PAAm and PVA in equal amounts and the highest borax concentration which could only be achieved in the hybrid system (2% PAAm, 2% PVA, and borax 10 mol %) was chosen for these experiments. Temperature ramps performed using DSC showed that the phase transitions (melting and crystallization) of CCH were intact within the salt hydrate entrapped within the salogel (FIG. 5A). In the thermograms, crystallization appears as a loop due to the substantial undercooling exhibited by this system, and the abrupt release of heat which accompanies nucleation followed by rapid solidification of a metastable liquid. This feature is due in part to the high sample mass (9.7 mg) and high scanning rate (10° C./min). Heat of fusion and melting temperature measurements from DSC experiments revealed that the thermal energy storage capability of the salogel was consistent with the amount of CCH (˜95 wt %) in the salogel (FIG. 5B), suggesting that the thermal transitions of CCH were not affected by the presence of entanglements, hydrogen bonds and dynamic covalent crosslinks in the polymer networks. The melting temperature was lowered only by ˜1° C. in the salogel as compared to pristine CCH. In contrast, the crystallization temperature was increased by ˜31° C. in the DSC indicating a reduced degree of supercooling in the salogel as compared to the neat salt hydrate PCM (FIG. 5A).

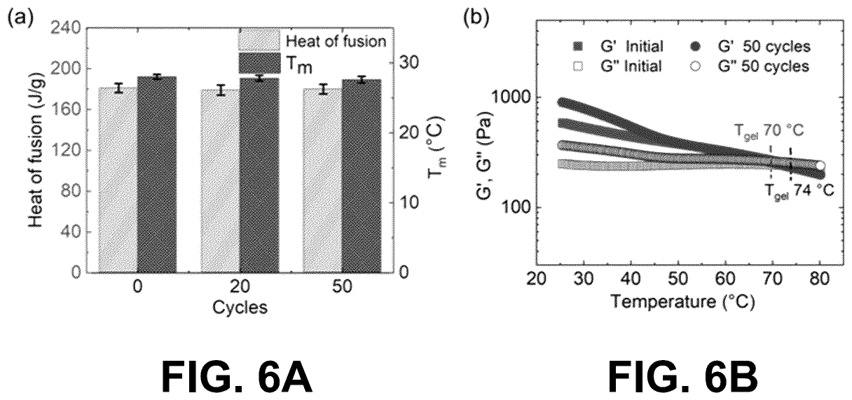

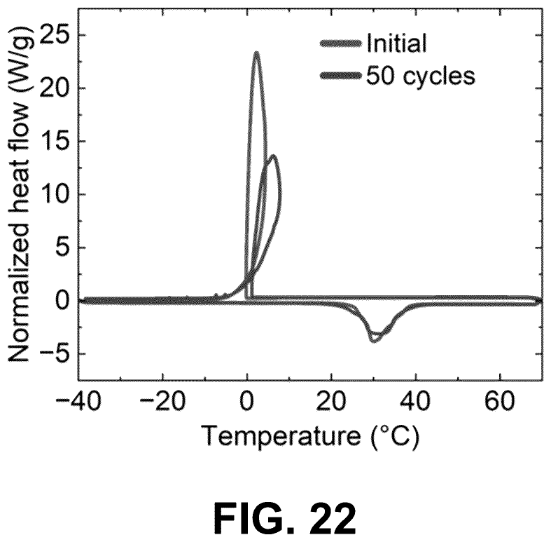

The thermal properties were also measured after 50 melting and crystallization as described in Materials and Methods. The thermal properties of the salt hydrate were retained after this thermal cycling treatment showing that the salogel network is robust and does not deteriorate the thermal properties of the PCM (FIGS. 6A, 22). Temperature sweep rheology experiments performed with the samples which were subjected to thermal cycling showed that the T_{gel} and mechanical properties of the salogel were not significantly changed after 50 cycles (FIG. 6B). Therefore, we conclude that the hybrid polymer network formed by entanglements, hydrogen bonding and dynamic covalent crosslinks did not deteriorate the thermal properties of the salt hydrate and was able to withstand at least 50 melting and crystallization cycles of CCH.

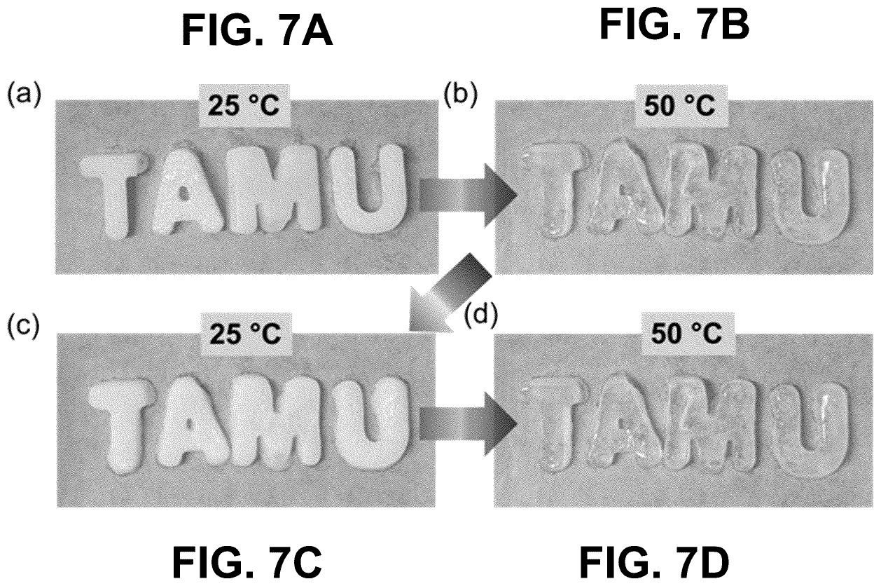

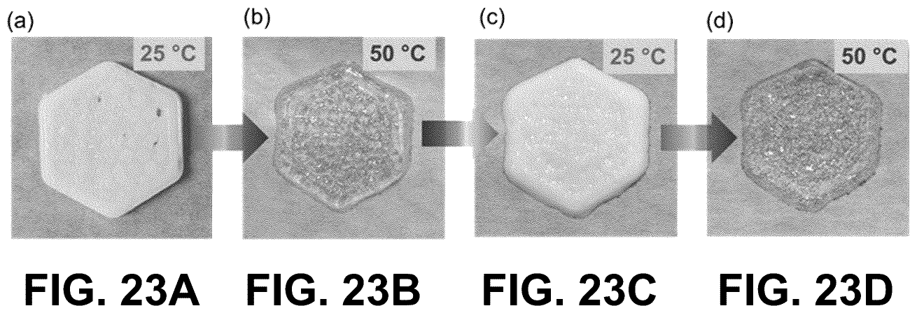

Finally, we demonstrate moldability and re-processing of the hybrid salogels. FIGS. 7A and 23A show that that the salogels can be processed in the sol state above their T_{gel} by molding them in “T”, “A”, “M”, and “U” shapes and hexagon shapes, followed by crystallizing the salogel-entrapped PCM. In addition, the shape stabilization ability of these salogels was tested by heating the salogel to 50° C. in an air-tight container to melt the PCM. The salogel containing PCM in the crystallized state appeared white and turned clear upon melting (FIGS. 7A, 7B, and 23A, 23B). Importantly, no leakage of PCM or loss of shape was observed during melting and after a second crystallization and melting cycle (FIGS. 7B, 7C, 7D, and 23C, 23D). These results show that the hybrid polymer matrix enabled the salogel to retain its shape while successfully entrapping CCH.

Table 1 compares hybrid salogels reported in this work with other systems reported in literature for CCH and its eutectics based on the amount of PCM in the shape stabilizing matrix and heat of fusion retained. Compared to impregnation of inorganic PCMs in porous matrices,⁴⁷⁻⁵⁰ encapsulation in polymer capsules, thickening with cellulosic²³ and superabsorbent polymer thickeners,²¹ and entrapment in covalently crosslinked PAAm,⁴⁰ the hybrid salogel developed in this work demonstrated more efficient entrapment of the salt hydrate, achieving more than 95% PCM content in the salogel. Due to the ability to trap a large amount of PCM with a small amount of polymer, the hybrid salogels showed the best heat of fusion retention of the pristine salt hydrate PCM. Importantly, the presence of secondary interactions (hydrogen bond, dynamic covalent crosslinks) along with entanglements in the hybrid polymer salogels supported shape stability and robust performance during thermal transitions, while conferring on-demand reversibility and tunability of gelation temperature not achievable with individual polymer components.

TABLE 1
Comparison of the developed salogels with other shape stabilization
systems for chloride salt hydrates reported in literature.

| | | | % | |
|---|---|---|---|---|
| | | PCM | Heat of | |
| | | amount | fusion | Reversi- |
| | Matrix | (wt %) | retention | bility |
| Zou et al. | Expanded graphite | 85 | 56 | No |
| (CaCl₂•6H₂O)⁴⁷ | | | | |
| Fu et al. | Expanded perlite | 55 | 46 | No |
| (CaCl₂•6H₂O)⁴⁸ | | | | |
| Zhang et al. | Diatomite | 58.3 | 57 | No |
| (CaCl₂•6H₂O)⁴⁹ | | | | |
| Tan et al. | Expanded graphite | 88 | 89 | No |
| (CaCl₂•6H₂O)⁵⁰ | | | | |
| Wu et al. | Polysiloxane/polyurea | 75 | 62 | No |
| (CaCl₂•6H₂O)⁵¹ | capsules | | | |
| Yang et al. | VOOH capsules | N/A | 53 | No |
| (CaCl₂•6H₂O)⁴⁰ | | | | |
| Bao et al. | Superabsorbent | 75 | 74 | N/A |
| (CaCl₂•6H₂O)²¹ | polymer thickener | | | |
| Li et al. | Hydroxyethyl | 77 | 73 | N/A |
| (CaCl₂•6H₂O— | cellulose | | | |
| MgCl₂•6H₂O)²³ | | | | |
| Wang et al. | Covalently | 96.2 | 75 | No |
| (CaCl₂•6H₂O— | crosslinked PAAm | | | |
| MgCl₂•6H₂O)⁴⁰ | | | | |
| This work | PAAm/boronate ester | 95.2 | 95 | Yes |
| (CaCl₂•6H₂O) | hybrid | | | |

### CONCLUSIONS

A hybrid salogel design strategy was demonstrated based on a combination of physical entanglements and dynamic covalent crosslinks to shape stabilize an inorganic PCM. The strategy was necessitated due to the significant effect of the anion type on gelation behavior of polymers in molten salt hydrates. The target PCM in this work was calcium chloride hexahydrate (CCH), an inexpensive and widely available salt hydrate PCM with high heat of fusion and near ambient melting temperature. However, weaker PVA/borax gels with lower T_{gel} were formed in the chloride salt hydrate CCH in comparison to the previously studied nitrate salt hydrate, CNH, due to the strong salting-out effect of chloride ions. To achieve shape stabilization at low polymer concentration (<5 wt %) with thermo-reversible gelation and tunable T_{gel} in CCH, a combination of boronate ester crosslinks with physical entanglements was used in this work by introducing an ultra-high molecular weight PAAm. Hydrogen bonding between PAAm and PVA within a joint, hybrid network supported a synergistic effect between the entanglements and dynamic covalent crosslinks to yield robust, shape stable yet temperature responsive salogels.

The salogels formed using this strategy retained ˜95% of the heat of fusion of CCH and only a small change in melting temperature while also providing shape stabilization above Tₘ of CCH and processability above T_{gel}, all at a low polymer and crosslinker concentration of ˜4.8% that is helpful for retention of high efficiency of this thermal energy storage materials. Finally, the hybrid salogels were easily moldable, and retained their mechanical and thermal properties after 50 melting/crystallization cycles.

### REFERENCES

1. Mohamed, S. A.; Al-Sulaiman, F. A.; Ibrahim, N. I.; Zahir, M. H.; Al-Ahmed, A.; Saidur, R.; Yilbaş, B. S.; Sahin, A. Z., A review on current status and challenges of inorganic phase change materials for thermal energy storage systems. Renewable and Sustainable Energy Reviews 2017, 70, 1072-1089.
2. da Cunha, S. R. L.; de Aguiar, J. L. B., Phase change materials and energy efficiency of buildings: A review of knowledge. Journal of Energy Storage 2020, 27, 101083.
3. Dixit, P.; Reddy, V. J.; Parvate, S.; Balwani, A.; Singh, J.; Maiti, T. K.; Dasari, A.; Chattopadhyay, S., Salt hydrate phase change materials: Current state of art and the road ahead. Journal of Energy Storage 2022, 51, 104360.
4. Qiu, L.; Yan, K.; Feng, Y.; Liu, X., Nano additives-enhanced PEG/AlN composites with high cycle stability to improve thermal and heat storage properties. Energy 2023, 278, 127794.
5. Sharma, A.; Shukla, A.; Chen, C. R.; Dwivedi, S., Development of phase change materials for building applications. Energy and Buildings 2013, 64, 403-407.
6. Kuznik, F.; David, D.; Johannes, K.; Roux, J.-J., A review on phase change materials integrated in building walls. Renewable and Sustainable Energy Reviews 2011, 15 (1), 379-391.
7. Qiu, L.; Yan, K.; Feng, Y.; Liu, X.; Zhang, X., Bionic hierarchical porous aluminum nitride ceramic composite phase change material with excellent heat transfer and storage performance. Composites Communications 2021, 27, 100892.
8. Kenisarin, M.; Mahkamov, K., Salt hydrates as latent heat storage materials: Thermophysical properties and costs. Solar Energy Materials and Solar Cells 2016, 145, 255-286.
9. Yu, K.; Liu, Y.; Yang, Y., Review on form-stable inorganic hydrated salt phase change materials: Preparation, characterization and effect on the thermophysical properties. Applied Energy 2021, 292, 116845.
10. Li, Y.; Kumar, N.; Hirschey, J.; Akamo, D. O.; Li, K.; Tugba, T.; Goswami, M.; Orlando, R.; LaClair, T. J.; Graham, S.; Gluesenkamp, K. R., Stable salt hydrate-based thermal energy storage materials. Composites Part B: Engineering 2022, 233, 109621.
11. Ryu, H. W.; Woo, S. W.; Shin, B. C.; Kim, S. D., Prevention of supercooling and stabilization of inorganic salt hydrates as latent heat storage materials. Solar Energy Materials and Solar Cells 1992, 27 (2), 161-172.
12. Byung Chul, S.; Sang Done, K.; Won-Hoon, P., Phase separation and supercooling of a latent heat-storage material. Energy 1989, 14 (12), 921-930.
13. Hou, P.; Mao, J.; Chen, F.; Li, Y.; Dong, X. Preparation and Thermal Performance Enhancement of Low Temperature Eutectic Composite Phase Change Materials Based on Na2SO4·10H2O Materials [Online], 2018.
14. Ding, C.; Liu, L.; Ma, F.; Chen, F.; Zhang, S.; Sun, T., Enhancing the Heat Storage Performance of a Na2HPO4·12H2O System via Introducing Multiwalled Carbon Nanotubes. ACS Omega 2021, 6 (43), 29091-29099.
15. Garay Ramirez, B. M. L.; Glorieux, C.; San Martin Martinez, E.; Flores Cuautle, J. J. A., Tuning of thermal properties of sodium acetate trihydrate by blending with polymer and silver nanoparticles. Applied Thermal Engineering 2014, 62 (2), 838-844.
16. Hu, P.; Lu, D.-J.; Fan, X.-Y.; Zhou, X.; Chen, Z.-S., Phase change performance of sodium acetate trihydrate with AlN nanoparticles and CMC. Solar Energy Materials and Solar Cells 2011, 95 (9), 2645-2649.
17. Cabeza, L. F.; Svensson, G.; Hiebler, S.; Mehling, H., Thermal performance of sodium acetate trihydrate thickened with different materials as phase change energy storage material. Applied Thermal Engineering 2003, 23 (13), 1697-1704.
18. Wada, T.; Yamamoto, R.; Matsuo, Y., Heat storage capacity of sodium acetate trihydrate during thermal cycling. Solar Energy 1984, 33 (3), 373-375.
19. Mao, J.; Dong, X.; Hou, P.; Lian, H., Preparation research of novel composite phase change materials based on sodium acetate trihydrate. Applied Thermal Engineering 2017, 118, 817-825.
20. Fashandi, M.; Leung, S. N., Sodium acetate trihydrate-chitin nanowhisker nanocomposites with enhanced phase change performance for thermal energy storage. Solar Energy Materials and Solar Cells 2018, 178, 259-265.
21. Bao, X.; Yang, H.; Xu, X.; Xu, T.; Cui, H.; Tang, W.; Sang, G.; Fung, W. H., Development of a stable inorganic phase change material for thermal energy storage in buildings. Solar Energy Materials and Solar Cells 2020, 208, 110420.
22. Xiao, Q.; Yuan, W.; Li, L.; Xu, T., Fabrication and characteristics of composite phase change material based on Ba(OH)2·8H2O for thermal energy storage. Solar Energy Materials and Solar Cells 2018, 179, 339-345.
23. Li, G.; Zhang, B.; Li, X.; Zhou, Y.; Sun, Q.; Yun, Q., The preparation, characterization and modification of a new phase change material: CaCl2·6H2O—MgCl2·6H2O eutectic hydrate salt. Solar Energy Materials and Solar Cells 2014, 126, 51-55.
24. Wang, T.; Wu, N.; Li, H.; Lu, Q.-L.; Jiang, Y., Preparation and properties of a form-stable phase-change hydrogel for thermal energy storage. Journal of Applied Polymer Science 2016, 133 (34).
25. Qi, X.; Zhu, T.; Hu, W.; Jiang, W.; Yang, J.; Lin, Q.; Wang, Y., Multifunctional polyacrylamide/hydrated salt/MXene phase change hydrogels with high thermal energy storage, photothermal conversion capability and strain sensitivity for personal healthcare. Composites Science and Technology 2023, 234, 109947.
26. Luo, Y.; Zou, L.; Qiao, J.; Zhang, J.; Liu, K.; Wu, H.; Lin, P.; Chen, Y., Boron Nitride-Doped Inorganic Hydrated Salt Gels Demonstrating Superior Thermal Energy Storage and Wearability Toward High-Performance Personal Thermal Management. ACS Applied Energy Materials 2022, 5 (9), 11591-11603.
27. Liu, Y.; Yu, K.; Gao, X.; Ren, M.; Jia, M.; Yang, Y., Enhanced thermal properties of hydrate salt/poly(acrylate sodium) copolymer hydrogel as form-stable phase change material via incorporation of hydroxyl carbon nanotubes. Solar Energy Materials and Solar Cells 2020, 208, 110387.
28. Luo, Y.; Yu, W.; Qiao, J.; Zhao, X.; Wu, H.; Sheng, X.; Chen, Y.; Lin, P., Self-healing inorganic hydrated salt gels for personal thermal management in the static and dynamic modes. Chemical Engineering Journal 2022, 440, 135632.
29. Liu, Y.; Yang, Y.; Li, S., Graphene oxide modified hydrate salt hydrogels: form-stable phase change materials for smart thermal management. Journal of Materials Chemistry A 2016, 4 (46), 18134-18143.
30. Liu, Y.; Yu, K.; Xie, M.; Lu, S.; Yang, Y.; Wang, H.; Jia, H., Hydrate salt/self-curing acrylic resin form-stable phase change materials with enhanced surface stability and thermal properties via the incorporation of graphene oxide. International Journal of Energy Research 2020, 44 (7), 5791-5805.
31. Yu, K.; Liu, Y.; Sun, F.; Jia, M.; Yang, Y., Graphene-Modified Hydrate Salt/UV-Curable Resin Form-Stable Phase Change Materials: Continuously Adjustable Phase Change Temperature and Ultrafast Solar-to-Thermal Conversion. Energy & Fuels 2019, 33 (8), 7634-7644.
32. Wang, T.; Qiu, X.; Chen, X.; Lu, L.; Zhou, B., Sponge-like form-stable phase change materials with embedded graphene oxide for enhancing the thermal storage efficiency and the temperature response in transport packaging applications. Applied Energy 2022, 325, 119832.
33. Yin, C.; Lan, J.; Wang, X.; Zhang, Y.; Ran, R.; Shi, L.-Y., Shape-Stable Hydrated Salts/Polyacrylamide Phase-Change Organohydrogels for Smart Temperature Management. ACS Applied Materials & Interfaces 2021, 13 (18), 21810-21821.
34. Lan, X. Z.; Tan, Z. C.; Shi, Q.; Gao, Z. H., Gelled Na₂HPO4·12H2O with amylose-g-sodium acrylate: heat storage performance, heat capacity and heat of fusion. Journal of Thermal Analysis and calorimetry 2009, 96 (3), 1035-1040.
35. Lan, X.-Z.; Tan, Z.-C.; Yue, D.-T.; Shi, Q.; Yang, C.-G., Heat Storage Performance of Disodium Hydrogen Phosphate Dodecahydrate: Prevention of Phase Separation by Thickening and Gelling Methods. Chinese Journal of Chemistry 2007, 25 (7), 921-925.
36. Shen, C.; Li, X.; Yang, G.; Wang, Y.; Zhao, L.; Mao, Z.; Wang, B.; Feng, X.; Sui, X., Shape-stabilized hydrated salt/paraffin composite phase change materials for advanced thermal energy storage and management. Chemical Engineering Journal 2020, 385, 123958.
37. Xiao, Q.; Fan, J.; Li, L.; Xu, T.; Yuan, W., Solar thermal energy storage based on sodium acetate trihydrate phase change hydrogels with excellent light-to-thermal conversion performance. Energy 2018, 165, 1240-1247.
38. Song, M.; Wang, L.; Shao, F.; Xie, H.; Xu, H.; Yu, W., Thermally induced flexible phase change hydrogels for solar thermal storage and human thermal management. Chemical Engineering Journal 2023, 464, 142682.
39. Liu, Q.; Zhang, J.; Liu, J.; Sun, W.; Xu, H.; Liu, C., Self-healed inorganic phase change materials for thermal energy harvesting and management. Applied Thermal Engineering 2023, 219, 119423.
40. Wang, Y.; Zhang, J.; Han, X.; Jiang, Y., Preparation and characterization of a form-stable phase change hydrogel for heat-protective clothing. New Journal of Chemistry 2023, 47 (4), 1818-1824. 41.

Karimineghlani, P.; Emmons, E.; Green, M. J.; Shamberger, P.; Sukhishvili, S. A., A temperature-responsive poly(vinyl alcohol) gel for controlling fluidity of an inorganic phase change material. Journal of Materials Chemistry A 2017, 5 (24), 12474-12482.
42. Rajagopalan, K. K.; Karimineghlani, P.; Zhu, X.; Shamberger, P. J.; Sukhishvili, S. A., Polymers in molten inorganic salt hydrate phase change materials: solubility and gelation. Journal of Materials Chemistry A 2021, 9 (46), 25892-25913.
43. Karimineghlani, P.; Palanisamy, A.; Sukhishvili, S. A., Self-Healing Phase Change Salogels with Tunable Gelation Temperature. ACS Applied Materials & Interfaces 2018, 10 (17), 14786-14795.
44. Rajagopalan, K. K.; Zhu, X.; Sukhishvili, S. A., Strong, thermo-reversible salogels with boronate ester bonds as thermal energy storage materials. Journal of Materials Chemistry A 2022, 10 (40), 21622-21632.
45. Cao, S.; Luo, X.; Han, X.; Lu, X.; Zou, C., Development of a New Modified CaCl2&middot; 6H2O Composite Phase Change Material. Energies 2022, 15 (3), 824.
46. Xu, X.; Cui, H.; Memon, S. A.; Yang, H.; Tang, W., Development of novel composite PCM for thermal energy storage using CaCl2·6H2O with graphene oxide and SrCl2·6H2O. Energy and Buildings 2017, 156, 163-172.
47. Zou, T.; Liang, X.; Wang, S.; Gao, X.; Zhang, Z.; Fang, Y., Effect of expanded graphite size on performances of modified CaCl2·6H2O phase change material for cold energy storage. Microporous and Mesoporous Materials 2020, 305, 110403.
48. Fu, L.; Wang, Q.; Ye, R.; Fang, X.; Zhang, Z., A calcium chloride hexahydrate/expanded perlite composite with good heat storage and insulation properties for building energy conservation. Renewable Energy 2017, 114, 733-743.
49. Zhang, X.; Li, X.; Zhou, Y.; Hai, C.; Shen, Y.; Ren, X.; Zeng, J., Calcium Chloride Hexahydrate/Diatomite/Paraffin as Composite Shape-Stabilized Phase-Change Material for Thermal Energy Storage. Energy & Fuels 2018, 32 (1), 916-921.
50. Tan, X.; Nian, H.; Li, J.; Zhou, Y.; Zhu, F.; Li, X., Modified Calcium Chloride Hexahydrate Lotus Root Starch/Expanded Graphite Shape-Stabilized Composite Phase Change Materials: Enhanced Heat Storage, Improved Heat Transfer, and Suppressed Supercooling Behavior. Energy & Fuels 2021, 35 (18), 15126-15132.
51. Wu, C.; Zhang, X.; Ning, B.; Yang, J.; Xie, Y., Shape Evolution of New-Phased Lepidocrocite VOOH from Single-Shelled to Double-Shelled Hollow Nanospheres on the Basis of Programmed Reaction-Temperature Strategy. Inorganic Chemistry 2009, 48 (13), 6044-6054.
52. Yang, J. M.; Kim, J. S., The microencapsulation of calcium chloride hexahydrate as a phase-change material by using the hybrid coupler of organoalkoxysilanes. Journal of Applied Polymer Science 2018, 135 (6), 45821.
53. Wu, S.; Hua, M.; Alsaid, Y.; Du, Y.; Ma, Y.; Zhao, Y.; Lo, C.-Y.; Wang, C.; Wu, D.; Yao, B.; Strzalka, J.; Zhou, H.; Zhu, X.; He, X., Poly (vinyl alcohol) Hydrogels with Broad-Range Tunable Mechanical Properties via the Hofmeister Effect. Advanced Materials 2021, 33 (11), 2007829.
54. Moghaddam, S. Z.; Thormann, E., The Hofmeister series: Specific ion effects in aqueous polymer solutions. Journal of Colloid and Interface Science 2019, 555, 615-635.
55. Zhang, Y.; Cremer, P. S., Interactions between macromolecules and ions: the Hofmeister series. Current Opinion in Chemical Biology 2006, 10 (6), 658-663.
56. Ochiai, H.; Kurita, Y.; Murakami, I., Viscosity behavior of the polyelectrolyte poly(vinyl alcohol) having some intrachain crosslinks. Die Makromolekulare Chemie 1984, 185 (1), 167-172.
57. Ochiai, H.; Kurita, Y.; Murakami, I., Intrinsic viscosity of intramolecularly crosslinked polyelectrolyte: Poly (vinyl alcohol)/borax systems. Die Makromolekulare Chemie 1988, 189 (2), 351-360.
58. Pezron, E.; Ricard, A.; Leibler, L., Rheology of galactomannan-borax gels. Journal of Polymer Science Part B: Polymer Physics 1990, 28 (13), 2445-2461.
59. Pezron, E.; Leibler, L.; Lafuma, F., Complex formation in polymer-ion solutions. 2. Polyelectrolyte effects. Macromolecules 1989, 22 (6), 2656-2662.
60. Kamiyama, Y.; Tamate, R.; Hiroi, T.; Samitsu, S.; Fujii, K.; Ueki, T., Highly stretchable and self-healable polymer gels from physical entanglements of ultrahigh-molecular weight polymers. Science Advances 2022, 8 (42), eadd0226.
61. Sadiek, G.; Almalki, S. Thermal Robustness of Entanglement in a Dissipative Two-Dimensional Spin System in an Inhomogeneous Magnetic Field Entropy [Online], 2021.
62. Kong, D.-C.; Yang, M.-H.; Zhang, X.-S.; Du, Z.-C.; Fu, Q.; Gao, X.-Q.; Gong, J.-W., Control of Polymer Properties by Entanglement: A Review. Macromolecular Materials and Engineering 2021, 306 (12), 2100536.
63. Carnali, J. O., Gelation in physically associating biopolymer systems. Rheologica Acta 1992, 31 (5), 399-412.
64. Zhang, H.; Feng, Y., Dependence of intrinsic viscosity and molecular size on molecular weight of partially hydrolyzed polyacrylamide. Journal of Applied Polymer Science 2021, 138 (34), 50850.
65. Kulicke, W. M.; Kniewske, R.; Klein, J., Preparation, characterization, solution properties and rheological behaviour of polyacrylamide. Progress in Polymer Science 1982, 8 (4), 373-468.

### Example 2

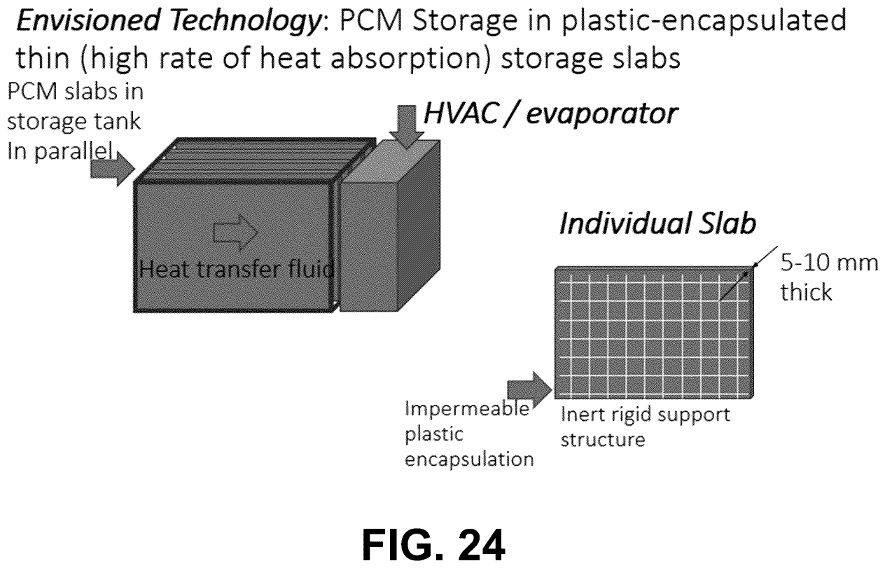

PCM Storage in plastic-encapsulated thin (high rate of heat absorption) storage slabs (FIG. 24)
PCM slabs are placed in a storage tank in parallel to each other
Each individual slab is 1-10 mm thick and contains an inert rigid support structure within an impermeable plastic encapsulation
Heat transfer fluid is present in the storage tank with the slabs, used in conjunction with a HVAC/evaporator, for example

Processing strategy
Heat above T_{g} to mix polymer/PCM/nucleation particles
Vacuum seal appropriate amount in a plastic encapsulated volume
Spread to even desired thickness (using rollers/press)
Cool below T_{g}
Use above and below Tₘ but always <T_{g}

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A hybrid salogel comprising:
a phase change material (PCM), wherein the hybrid salogel includes about 94 to 99 weight percent of the PCM;
a polymer mixture comprising a first polymer and a second polymer, wherein the first polymer is selected from the group consisting of: a polyvinyl alcohol (PVA), a copolymer of PVA, and a homopolymer containing a plurality of hydroxyl groups, wherein the second polymer is polyacrylamide (PAAm) or a copolymer of PAAm, wherein the hybrid salogel includes about 0.2 to about 5 weight percent of the polymer mixture; and
a crosslinker, wherein the hybrid salogel includes about 0.1 to 0.5 weight percent of the crosslinker.

2. The hybrid salogel of claim 1, wherein the PCM is an inorganic salt hydrate.

3. The hybrid salogel of claim 2, wherein the inorganic salt hydrate is a stoichiometric chloride hydrate, a mixture of chloride hydrates optionally including anhydrous chlorides, a stoichiometric nitrate hydrate, a mixture of nitrate hydrates optionally including anhydrous nitrates, a stoichiometric sulfate hydrate, a mixture of sulfate hydrates optionally including anhydrous sulfates, a mixture of salt hydrates with different anions, and mixtures thereof.

4. The hybrid salogel of claim 2, wherein the inorganic salt hydrate is selected from the group consisting of: CaCl₂·6H₂O, MgCl₂·6H₂O, LiCl·H₂O, MnCl₂·4H₂O, CaCl₂·6H₂O—MgCl₂·6H₂O, CaCl₂·6H₂O—MnCl₂·6H₂O, NaCl, KCl, NH₄Cl, LiNO₃·3H₂O, Mg(NO₃)₂·6H₂O, Ca(NO₃)₂·4H₂O, Zn(NO₃)₂·6H₂O, Fe (NO₃)₂·9H₂O, LiNO₃·3H₂O—Zn(NO₃)₂·6H₂O, Mg(NO₃)₂·6H₂O—Zn(NO₃)₂·6H₂O, NaNO₃, KNO₃, NH₄NO₃, Na₂SO₄·10H₂O, Al₂(SO₄)₃·18H₂O, MgSO₄·7H₂O, Na₂SO₄·10H₂O—MgSO₄·7H₂O, CaBr₂·6H₂O, CaCl₂·6H₂O—Ca(NO₃)₂·4H₂O, CaCl₂·6H₂O—CaBr₂·6H₂O, and mixtures thereof and eutectic mixtures thereof.

5. The hybrid salogel of claim 1, wherein the crosslinker includes borax type crosslinkers.

6. The hybrid salogel of claim 1, wherein the crosslinker includes boronic acid, chromate, antimonate, titanate, or mixtures thereof.

7. The hybrid salogel of claim 1, wherein the crosslinker is selected from: sodium tetraborate decahydrate (borax), Na₂B₄O₇·10H₂O; anhydrous borax, Na₂B₄O₇; boric acid, H₃BO₃; sodium metaborate, NaBO₂; sodium perborate, Na₂B₂O₄; zinc borate, 2ZnO·3B₂O₃·3.5H₂O; ammonium pentaborate tetrahydrate, NH₄B₅O₈·4H₂O; disodium tetraborate pentahydrate, Na₂—B₄O₇·5H₂O; sodium tetraborate pentahydrate, Na₂B₄O₇··5H₂O; disodium octaborate tetrahydrate, Na₂B₈O₁₃·4H₂O; potassium pentaborate tetrahydrate, KB₅O₈·4H₂O; potassium tetraborate tetrahydrate, K₂B₄O₇·4H₂O; sodium pentaborate, NaB₅O₈·5H₂O; sodium metaborate dihydrate, Na₂B₂O₄·4H₂O; sodium metaborate tetrahydrate, Na₂B₂O₄·8H₂O; dicalcium hexaborate pentahydrate, 2ZnO·3B₂O₃·5H₂O; tetrahydroxy diboron; 1,4-phenylene diboronic acid; 4-formyl phenyl boronic acid; pyridine-4-boronic acid; tri (dioctylpyrophosphoryloxy) isopropyl titanate; chromic nitrate; potassium pyroantimoniate; or mixtures thereof.

8. The hybrid salogel of claim 1, wherein the polymer mixture further comprises at least one of:
a neutral polymer;
a polar polymer comprising carboxylic acid groups, wherein the carboxylic acid groups comprise at least two functional groups on every monomer unit;
a polar polymer comprising amine functional groups, wherein the amine functional groups comprise at least two functional groups on every monomer unit;
a polar polymer comprising hydroxyl functional groups, wherein the hydroxyl functional groups comprise at least two functional groups on every monomer unit;
a polar polymer comprising amide functional groups, wherein the amide functional groups comprise at least two functional groups on every monomer unit; or
a polyethylene glycol/polyethylene oxide.

9. A method for preparing a hybrid salogel, the method comprising:
adding a polymer powder into a liquid phase change material (PCM) to form a mixture, wherein the polymer powder comprises polyvinyl alcohol (PVA) and polyacrylamide (PAAm);
dissolving the powder in the liquid PCM and forming a homogeneous solution;
gelling the homogeneous solution; and
dissolving the polymer powder into water followed by dissolving a desired quantity of anhydrous salt into a liquid, forming a homogeneous solution.

10. The method of claim 9, wherein the mixture includes about 94 to 99 weight percent of the PCM and wherein the mixture includes about 0.2 to about 5 weight percent of the polymer powder.

11. The method of claim 9, wherein the PCM is an inorganic salt hydrate.

12. The method of claim 11, wherein the inorganic salt hydrate is a stoichiometric chloride hydrate, a mixture of chloride hydrates optionally including anhydrous chlorides, a stoichiometric nitrate hydrate, a mixture of nitrate hydrates optionally including anhydrous nitrates, a stoichiometric sulfate hydrate, a mixture of sulfate hydrates optionally including anhydrous sulfates, a mixture of salt hydrates with different anions, and mixtures thereof.

13. The method of claim 11, wherein the inorganic salt hydrate is CaCl₂·6H₂O, MgCl₂·6H₂O, LiCl·H₂O, MnCl₂·4H₂O, CaCl₂·6H₂O—MgCl₂·6H₂O, CaCl₂·6H₂O—MnCl₂·6H₂O, NaCl, KCl, NH₄Cl, LiNO₃·3H₂O, Mg(NO₃)₂·6H₂O, Ca(NO₃)₂·4H₂O, Zn(NO₃)₂·6H₂O, Fe (NO₃)₂·9H₂O, LiNO₃·3H₂O—Zn(NO₃)₂·6H₂O, Mg(NO₃)₂·6H₂O—Zn(NO₃)₂·6H₂O, NaNO₃, KNO₃, NH₄NO₃, Na₂SO₄·10H₂O, Al₂(SO₄)₃·18H₂O, MgSO₄·7H₂O, Na₂SO₄·10H₂O—MgSO₄·7H₂O, CaBr₂·6H₂O, CaCl₂·6H₂O—Ca(NO₃)₂·4H₂O, CaCl₂·6H₂O—CaBr₂·6H₂O, mixtures thereof and eutectic mixtures thereof.

14. The method of claim 9, further comprising:
adding a crosslinker to the mixture after the powder is dissolved, wherein the crosslinker includes borax type crosslinkers.

15. The method of claim 14, wherein the crosslinker includes boronic acid, chromate, antimonate, titanate, or mixtures thereof.

16. The method of claim 14, wherein the mixture includes about 0.1 to 0.5 weight percent of the crosslinker.

17. The method of claim 14, wherein the crosslinker is selected from: sodium tetraborate decahydrate (borax), Na₂B₄O₇·10H₂O; anhydrous borax, Na₂B₄O₇; boric acid, H₃BO₃; sodium metaborate, NaBO₂; sodium perborate, Na₂B₂O₄; zinc borate, 2ZnO·3B₂O₃·3.5H₂O; ammonium pentaborate tetrahydrate, NH₄B₅O₈·4H₂O; disodium tetraborate pentahydrate, Na₂B₄O₇·5H₂O; sodium tetraborate pentahydrate, Na₂B₄O₇·5H₂O; disodium octaborate tetrahydrate, Na₂B₈O₁₃·4H₂O; potassium pentaborate tetrahydrate, KB₅O₈·4H₂O; potassium tetraborate tetrahydrate, K₂B₄O₇·4H₂O; sodium pentaborate, NaB₅O₈·5H₂O; sodium metaborate dihydrate, Na₂B₂O₄·4H₂O; sodium metaborate tetrahydrate, Na₂B₂O₄·8H₂O; dicalcium hexaborate pentahydrate, 2ZnO·3B₂O₃·5H₂O; tetrahydroxy diboron; 1,4-phenylene diboronic acid; 4-formyl phenyl boronic acid; pyridine-4-boronic acid; tri (dioctylpyrophosphoryloxy) isopropyl titanate; chromic nitrate; potassium pyroantimoniate; or mixtures thereof.

18. A structure, comprising: a hybrid salogel of claim 1.

19. The structure of claim 18, wherein the structure is selected from the group consisting of: a storage slab, a storage sheet, a storage pouch, a plate-fin heat exchanger, a shell and tube heat exchanger, a finned tube heat exchanger, a spiral tube heat exchanger, cement, concrete, brick, cinder block, drywall, ceiling tiles, flooring, a textile, and a fabric.

20. The structure of claim 18, wherein the PCM is a micro-encapsulated PCM.
